(19) United States
(12) Patent Application Publication
(10) Pub. No.: US 2026/0220873 A1
(43) Pub. Date: Jul. 30, 2026

(54) IMAGE SPACE ADAPTIVE SAMPLING FOR LIGHT TRANSPORT SIMULATION SYSTEMS AND APPLICATION

(71) Applicant: NVIDIA Corporation, Santa Clara, CA (US)

(72) Inventors: Filip Strugar, Henley-in-Arden (GB); Oliver Mark Wright, Northwich (GB); Jiayin Cao, Irvine, CA (US)

(21) Appl. No.: 19/041,224

(22) Filed: Jan. 30, 2025

(51) Int. Cl. G06T 15/06; G06T 15/50

(52) U.S. Cl. CPC G06T 15/06; G06T 15/506

(57) ABSTRACT

In various examples, per-pixel statistics from light sampling events—such as Next Event Estimation (NEE) sampling events—may be obtained and used to guide future light sampling during the rendering of subsequent frames or images. For instance, the systems and methods of the present disclosure may use weighted reservoir sampling to stochastically store (e.g., in image space) light sampling statistics indicative of light sources that contributed the most to the radiance of each pixel of a first rendered image. Using these statistics, one or more sampling distributions may be generated for future rendering passes of subsequent images. For instance, a global sampling distribution specific to the whole frame and one or more local sampling distributions specific to different groups of pixels (e.g., tiles) within the frame may be generated and used to guide sampling events for rendering a second image.

### BACKGROUND

To simulate lighting in a virtual scene, modern rendering techniques—such as path tracing—may model the interactions of light as it bounces between surfaces, passes through media, and ultimately reaches the observer. In path tracing, for instance, the light contribution to each pixel may be calculated by iterating over multiple light paths, using Monte Carlo methods for random sampling. However, this stochastic process often requires a large number of samples to reduce noise and generate high-quality images, thereby making it computationally intensive. To improve the efficiency of path tracing, Next Event Estimation (NEE) (and/or other techniques) may be used to accelerate convergence by directly sampling light sources at each bounce (or vertex) in addition to tracing light through the Bidirectional Scattering Distribution Function (BSDF). While NEE may help reduce noise and improve image quality, it may also introduce additional computational overhead for testing the visibility of light sources.

However, in large dynamic scenes with numerous light sources, the computational cost of using path tracing with NEE may become substantial if the visibility for every potential light source at each vertex needs to be tested. As a result, the amount of time taken to sample light paths and evaluate visibility can grow significantly in these scenarios, thereby reducing overall efficiency. Additionally, basic optimization techniques—such as intensity-based light importance sampling—may struggle to perform effectively in complex environments as these methods usually rely on a fixed distribution of light sampling and may not adapt well to scenes with highly variable lighting conditions and/or numerous light sources. As such, these methods may oversample less important areas and/or fail to properly account for subtle lighting effects, leading to inefficient rendering and/or increased noise.

### SUMMARY

Embodiments of the present disclosure relate to image space adaptive sampling for light transport simulation systems and application. Systems and methods are disclosed for generating and/or using per-pixel statistics from light sampling events—such as Next Event Estimation (NEE) sampling events—to guide future light sampling during the rendering of subsequent frames or images. For instance, the systems and methods of the present disclosure may use weighted reservoir sampling to stochastically store (e.g., in image space) light sampling statistics indicative of light sources that contributed the most to the radiance of each pixel of a first rendered image. Using these statistics, one or more sampling distributions may be generated and/or continuously updated (e.g., after each subsequent frame) to guide light sampling for future rendering passes of subsequent frames. For instance, a global sampling distribution specific to the whole frame and one or more local sampling distributions specific to different groups of pixels (e.g., tiles) within the frame may be generated and used to guide sampling events for rendering a second image. In various examples, these sampling distributions may be computed with O(1) algorithmic complexity, and weighted using Multiple Importance Sampling (MIS) to optimize the distribution of light samples and reduce variance.

In contrast to conventional approaches, the systems and methods of the present disclosure, in some examples, may provide high quality initial light candidate selection and/or standalone real-time lighting solutions for Path Tracing with NEE. For instance, by considering all light candidates at the same time—as well as accounting for both light-surface interactions (e.g., BSDF) and light-surface visibility (e.g., shadowing) at the same time—the systems and methods of the present disclosure may be able to render images with reduced noise and/or “boiling” artifacts, in contrast to conventional systems. Additionally, by sharing light importance information across pixels in image space, the systems and methods of the present disclosure are able to achieve increased fidelity (e.g., lower noise) than conventional systems. Furthermore, the systems of the present disclosure are able to support directional lighting, Image-Based Lighting (IBL) (e.g., using environment maps), and/or non-standard light types—such as collimated beams (e.g., car headlamps)—without needing specialized support, in contrast to conventional systems.

### BRIEF DESCRIPTION OF THE DRAWINGS

The present systems and methods for image space adaptive sampling for light transport simulation systems and application are described in detail below with reference to the attached drawing figures, wherein:

FIG. 1 is a data flow diagram illustrating an example of a process for generating and using per-pixel statistics from light sampling events to guide future light sampling, in accordance with some embodiments of the present disclosure;

FIG. 2 illustrates an example of Path Tracing with Next Event Estimation, in accordance with some embodiments of the present disclosure;

FIG. 3 is a data flow diagram illustrating an example of storing per-pixel light sampling statistics in image space reservoirs, in accordance with some embodiments of the present disclosure;

FIG. 4A illustrates an example associated with a global light importance sampling distribution, in accordance with some embodiments of the present disclosure;

FIG. 4B illustrates an example associated with a local light importance sampling distribution, in accordance with some embodiments of the present disclosure;

FIG. 5 illustrates an example of a system that may perform one or more of the processes described herein, in accordance with some embodiments of the present disclosure;

FIG. 6 is a flow diagram illustrating an example of a method for generating a global light importance sampling distribution, in accordance with some embodiments of the present disclosure;

FIG. 7 is a flow diagram illustrating an example of a method for generating local light importance sampling distributions, in accordance with some embodiments of the present disclosure;

FIG. 8 is a flow diagram illustrating an example of a method for storing light sampling statistics in per-pixel reservoirs, in accordance with some embodiments of the present disclosure;

FIG. 9 is a flow diagram illustrating an example of a method for using light sampling statistics to generate global and local sampling distributions, in accordance with some embodiments of the present disclosure;

FIG. 10 is a flow diagram illustrating an example of a method for using global and local sampling distributions to guide future light sampling during the rendering of an image, in accordance with some embodiments of the present disclosure;

FIG. 11 illustrates an example parallel processing unit suitable for use in implementing at least some embodiments of the present disclosure;

FIG. 12A illustrates an example general processing cluster within the parallel processing unit of FIG. 11 suitable for use in implementing at least some embodiments of the present disclosure;

FIG. 12B illustrates an example memory partition unit of the parallel processing unit of FIG. 11 suitable for use in implementing at least some embodiments of the present disclosure;

FIG. 13A illustrates an example of the streaming multi-processor of FIG. 12A suitable for use in implementing at least some embodiments of the present disclosure;

FIG. 13B is an example conceptual diagram of a processing system implemented using the PPU of FIG. 11 suitable for use in implementing at least some embodiments of the present disclosure;

FIG. 13C illustrates an example system in which the various architecture and/or functionality of the various embodiments may be implemented;

FIG. 14 illustrates an example ray tracing pipeline suitable for use in implementing at least some embodiments of the present disclosure;

FIG. 15 illustrates an example acceleration structure suitable for use in implementing at least some embodiments of the present disclosure;

FIG. 16 illustrates an example shader record suitable for use in implementing at least some embodiments of the present disclosure;

FIG. 17 is a block diagram of an example computing device suitable for use in implementing some embodiments of the present disclosure; and

FIG. 18 is a block diagram of an example data center suitable for use in implementing some embodiments of the present disclosure.

### DETAILED DESCRIPTION

Systems and methods are disclosed related to image space adaptive sampling for light transport simulation systems and application. As described herein, in some examples, the systems and methods of the present disclosure may generate, update, and/or use per-pixel statistics from light sampling events (e.g., Next Event Estimation (NEE) light sampling events) to guide future light sampling during the rendering of subsequent frames/images. For instance, using weighted reservoir sampling, per-pixel light sampling statistics may be stochastically stored in image space. In some instances, the statistics may be indicative of the most important light sources in the scene (e.g., the light emitters that contributed the most to the lighting in the scene), and the statistics may be used to generate and/or update light sampling distributions for guiding future light sampling events. For instance, a global sampling distribution specific to the whole frame and one or more local sampling distributions specific to different groups of pixels (e.g., tiles) within the frame may be generated and used to guide sampling events for rendering a second image. In various examples, these sampling distributions may be computed with O(1) algorithmic complexity and weighted using Multiple Importance Sampling (MIS) to optimize the distribution of light samples and reduce variance.

By way of example, and not limitation, a system(s) may obtain scene data associated with a virtual environment to be rendered into an image. The scene data may indicate various properties of the environment, such as the positions, intensities, and/or types of light sources, as well as the geometry, materials, and/or textures of objects or other surfaces within the scene. In some examples, the system(s) may use the scene data to accurately simulate the interactions between light and surfaces during the rendering process. For instance, the system(s) may process the scene data to, among other things, calculate how much light is emitted from each source, the paths that light rays take through the scene, and/or the materials' reflective or absorptive properties that affect how light contributes to the final image.

In some examples, the system(s) may use the scene data to generate an importance light sampling distribution (also referred to herein as a “global importance sampling distribution”) based on the intensity (e.g., emissive flux) of the light sources within the virtual environment. For instance, the system(s) may compute the weight of at least one light source (e.g., each light source in the virtual environment, each light source in the particular scene, etc.), which may define the light source's probability of being selected for sampling. In some instances, a light source's weight may be based on the light's emissive flux, with brighter lights receiving higher weights and dimmer lights receiving lower weights. Additionally, or alternatively, the system(s) may apply one or more custom modifiers to adjust these weights. For example, to reduce light sampling noise from lights that are near the camera, the system(s) may scale the weight by the inverse of the light's distance from the camera. In some examples, the system(s) may sum the weights of all the light sources and normalize these values, which may ensure that the total probability of selecting any light equals one. As described in further detail herein, the per-light weights may be further modified or updated based on historic light usage feedback from previous rendered frames. However, if the current frame being rendered is the first frame of a series of frames, the historic light usage feedback may not be available.

In some instances, and as part of generating the importance light sampling distribution, the sampling system(s) may rely on a layer of indirection when obtaining light samples by relying on sampling proxies. The system(s) may compute how many proxies are needed for each light source, with the number of proxies being proportional to the light's weight. The proxies may be pre-allocated and stored in a proxy table, with each entry containing the light's unique index and the corresponding number of proxies. The system(s) may rely on uniform sampling of proxies, which may efficiently (e.g., with O(1) algorithmic complexity) approximate Inverse Transform Sampling of discrete distributions while avoiding computation of Cumulative Distribution Functions and/or binary searches needed for sampling when using classical approaches (e.g., O(log(n) algorithmic complexity). This may allow the system(s) to efficiently manage light sampling during the rendering process. In some examples, the proxy table may be filled in a deterministic and unfragmented manner, which may improve temporal and spatial coherence. Additionally, in some instances, the system(s) may optionally sort the list of light sources included in the importance light sampling distribution by their Morton space-filling curve index, optimizing cache coherence and improving memory access patterns during sampling. This spatial sorting may also benefit low-discrepancy sampling by preserving the locality of light sources in image space, ensuring efficient sampling even in large and complex scenes.

In various examples, the system(s) may obtain a plurality of samples using the importance light sampling distribution. That is, the system(s) may sample the light sources in the scene based on their weights (e.g., intensity-based weights) in the importance sampling distribution. By using the importance sampling distribution based on light intensity for sampling light sources may help the system(s) improve rendering efficiency by prioritizing lights that contribute more significantly to illumination of the scene. This may reduce variance in Monte Carlo estimates by focusing samples on brighter or more influential light sources, leading to faster convergence and higher-quality results in global illumination computations. As described herein, the samples may include, in some instances, NEE samples, Bidirectional Scattering Distribution Function (BSDF) samples, or any other kind of samples indicating which light sources are contributing to the illumination or shading of which surfaces in the virtual environment/scene that is to be depicted in the first image. For instance, the samples may be generated or obtained using one or more light transport simulation techniques, such as ray tracing, path tracing, NEE path tracing, or any other kind of sampling during the rendering of the first image. In some instances, the system(s) may use the samples of the current rendering frame to compute the final illumination values for each pixel in the current image, taking into account both direct and indirect lighting, material properties, and the geometry of the scene, to produce a realistic and high-quality render.

As described herein, in various examples, the system(s) may use the samples to determine the lights sources that contributed the most to the illumination of different portions of the scene depicted in the first image, and then use this information to determine or generate sampling distributions for sampling light sources during the rendering of subsequent images (e.g., a second image, a third image, and so forth). For instance, the system(s) may continuously use weighted reservoir sampling to store light usage statistics and keep track of the most important contributing lights per-pixel of the first image (or each rendered image/frame), and then use those statistics to update or modify the global importance sampling distribution for a second image (or the next frame and/or series of frames).

In some examples, the system(s) may obtain and process the samples and determine feedback weights associated with each sample. For instance, the system(s) may gather and process an image-space usage histogram to determine, for each pixel sample, a light index (e.g., identifier) corresponding to a selected light source and that light source's contribution to the pixel's radiance. In some examples, the radiance contribution for the image pixel being rendered may consist of direct emitter connections from the (e.g., main branch) path vertices and from NEE. In the case of NEE, the system(s) may inherently know the index of the light that that has been sampled and whether that light has passed the segment visibility test. In the case of a path vertex landing on an emissive triangle, the system(s) may know the light index corresponding to the emissive triangle (e.g., as it may be precomputed in a separate lookup table during light emitter precomputation). By knowing each contributing sample's light's index and its contribution radiance (which may inherently encode BSDF throughput, visibility, and/or selection probability), the system(s) may create the per-light sampling feedback to guide future NEE sampling, and help the system(s) use NEE to find important light contributors more quickly.

In some instances, the system(s) may calculate “feedback” weights for the samples (as distinguishable from each light's importance sampling distribution weight). The system(s) may use the feedback weights for the samples/lights as part of weighted reservoir sampling to store the most important contributing light sources for each image pixel, which may then be fed back into the algorithm in the next rendering frame for generating importance sampling distributions. In some instances, the weight may be based on the luminance of the input radiance, which may represent the perceived brightness of the light contributed by the sampled source (e.g., calculated as the max3 value of the RGB components). This radiance value may already be adjusted by dividing it by the total probability density as part of the Monte Carlo integration process. On the other hand, if the segment fails the visibility test, the weight may be set to zero.

In at least one example, the feedback weight may be multiplied by the light selection probability to the power of α, where 0.05≤α≤0.5, which may help avoid unwanted hysteresis. Additionally, or alternatively, the system(s) may use a non-zero weight multiplier β (β≤0.1) to include currently shadowed lights, which may be beneficial in dynamic scenarios when shadowing changes from frame to frame.

As mentioned above and described herein, to optimize the usage of computational and storage resources, the system(s) may, in some instances, use weighted reservoir sampling to keep track of a subset (e.g., one or more) of the most important contributing light sources per image pixel, instead of tracking or storing all light sampling events from NEE. For example, the system(s) may use per-pixel reservoirs (e.g., data structures) to store light sampling statistics indicating relative contributions of the light sources to the radiance values of each pixel in the first image. In some instances, each reservoir may store a light index (e.g., identifier) corresponding to one or more rays of a sampled light source that contributed to the radiance value of a certain pixel in the image, the feedback weight associated with that sampled light source, and the total weights of all the sampled light sources for that certain pixel. In other words, one or multiple reservoirs may be stored for each image pixel (e.g., 1-4 reservoirs per pixel), and each reservoir may ultimately yield a single light index, that light index's feedback weight, and the total weight of all candidate lights considered.

In some instances, one or more first reservoirs corresponding to a specific pixel may be used to store statistics for more specular/direct parts of a path, while one or more second reservoirs corresponding to the same pixel may be used to store statistics for more diffuse parts of the path. In such instances, the system(s) may begin with filling the first reservoir(s), handling light contributions with more specular or direct characteristics. As the path of the light ray(s) continues to bounce, the system(s) may evaluate the path's scattering properties and, when it determines that the path has become predominantly diffuse (or diffuse by more than a threshold), the system(s) may switch contributions to the second reservoir(s). This approach may enable more effective sampling and storage tailored to the lighting characteristics of different path segments.

In some examples, the reservoirs may be stored in 12 bytes of memory. For instance, the index, weight, and total weight may each be 4-byte values. Additionally, or alternatively, to further reduce memory requirements, the system(s) may store the index's weight and the total weights as 16-bit floats (e.g., using a half-precision floating-point format). The values stored in the reservoirs, in some instances, may be required only during the path tracing process and therefore may not need to be allocated in VRAM. Instead, these values may reside in GPU registers or temporary thread-local memory, enabling faster access and reduced memory overhead. In at least one example, in addition to providing feedback from NEE light sampling, the system(s) may also provide feedback from the main path when it encounters emissive geometry or ends sampling on the environment map.

As described herein, the rendering pass for the first image may produce a buffer of per-pixel reservoirs storing light usage statistics for each pixel, which may effectively represent a stochastic representation of lights with the highest contribution to the image of the previous frame. The system(s) may use this buffer of per-pixel reservoirs in the next rendering pass/frame to guide the generation of the global light importance sampling distribution, as well as to generate local light importance sampling distributions. In some instances, and as described in greater detail below, the system(s) may perform post-processing (if during the first rendering frame) or pre-processing (if during the second rendering frame) of the per-pixel light usage statistics to update or modify the information and make it more useful in the next rendering frame. The pre/post-processing steps may include, in some instances, mapping light indices from the previous frame to the current frame, filling in values for pixels with no entry(ies) in the reservoirs, accounting for camera and/or scene motion, downsampling the feedback reservoirs, and/or any other pre/post-processing operations.

In various examples, the system(s) may use the light usage statistics stored in the per-pixel reservoirs during the previous rendering frame (e.g., the first image) to guide generation of light sampling distributions for the current/next rendering frame (e.g., the second image). For instance, the system(s) may use the light usage statistics from the per-pixel reservoirs to generate/update the global importance sampling in the next rendering frame. In some examples, to generate/update the global importance sampling distribution, the system(s) may initialize a buffer of unsigned integer counters for each light source and set each counter to zero. The system(s) may then evaluate the per-pixel reservoirs to determine the number of times each light source/index appears in the reservoirs. As an example, the system(s) may determine that a first number of the reservoirs are storing a first index value corresponding to a first light source, a second number of the reservoirs are storing a second index value corresponding to a second light source, a third number of the reservoirs are storing a third index values corresponding to a third light source, and so forth. The system(s) may compute normalized per-light feedback weights based on the number of times each light source appears in the reservoirs, and use these normalized per-light feedback weights to update/modify the intensity-based per-light weights corresponding to the light sources included in the global importance sampling distribution.

Additionally, in some instances the system(s) may use the historic light usage statistics stored in the per-pixel reservoirs to generate local importance sampling distributions for guiding the light importance sampling in the next rendering frame. The local importance sampling distributions may be indicative of which lights in the virtual environment contributed most to illumination/pixel radiance for specific portions of the previously rendered image (e.g., locally relevant lights). For instance, to generate the local importance sampling distributions, the system(s) may logically split the image/frame into a plurality of pixel tiles (e.g., 4×4 pixel tiles, 8×8 pixel tiles, 16×16 pixel tiles, 32×32 pixel tiles, etc.) and compute local, per-tile light sampling distributions. To do this, the system(s) may evaluate each tile individually to determine how many times each light index was listed as the highest contributing light source for each pixel. As an example, for a 4×4 pixel tile that includes 16 pixels, the system(s) may determine (based on the information/statistics stored in the per-pixel reservoirs) that a first light source was the highest contributor to radiance for 8 of the pixels, that a second light source was the highest contributor to radiance for 6 of the pixels, and that a third light source was the highest contributor to radiance for the remaining 2 of the pixels. The system(s) may then generate the local sampling distribution for this 4×4 pixel tile, with the light sources having weights proportional to the number of times each light was listed as the highest contributor to pixel radiance.

In some examples, the system(s) may use the global and local sampling distributions to guide the sampling of light sources in the scene for the second image, and then render the second image of the virtual environment based on the sampling. That is, during light sampling in NEE, each path may have two light sampling distributions to pick from: the global light sampling distribution or the local light sampling distribution. If the paths sample from the global light sampling distribution alone, the rendered images may eventually converge to ground truth. In contrast, because the local light sampling distribution may not cover all the light sources contributing to the frame, sampling from the local light sampling distribution alone may not converge to the correct result. Thus, the system(s) of the present disclosure may sample from both of these distributions to get an unbiased result, while benefiting from locally adaptive sampling. To do this, in some instances, the system(s) may use at least one sample from the global distribution and one or more samples from the local distribution, and weigh the samples using multiple importance sampling with a balancing heuristic.

In some examples, to perform multiple importance sampling, the system(s) may compute a probability distribution function (PDF) for a given light sample in both sampling distributions. For instance, when drawing a light sample from the global distribution, the system(s) may search the corresponding local distribution in order to find the light's selection probability. Similarly, when drawing a light sample from the local distribution, the system(s) may obtain the light's selection probability in the global distribution at O(1) since the system(s) may store per-light proxy counters globally. In some examples, when used in conjunction with BSDF sampling in a path tracer, the system(s) may have a 3-way multiple importance sampling where one sample comes from BSDF, one sample comes from the global distribution, and one sample comes from the local distribution. In such an example, if a sample is drawn from a first distribution, the system(s) may be able to determine what the PDF is for the sample being drawn from the second and the third distributions, and compute weights for all three.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

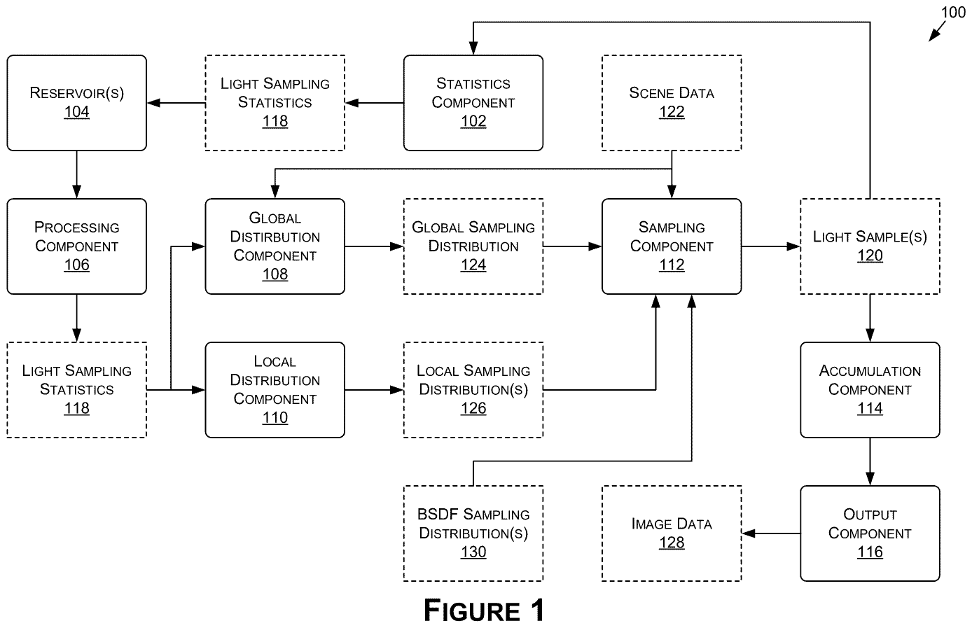

With reference to FIG. 1, FIG. 1 is a data flow diagram illustrating an example of a process 100 for generating and using per-pixel statistics from light sampling events to guide future light sampling, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in the example of FIG. 1, the process 100 may be implemented using, amongst additional or alternative components, a statistics component 102, one or more reservoirs 104, a processing component 106, a global distribution component 108, a local distribution component 110, a sampling component 112, an accumulation component 114, and an output component 116. In some examples, and as described herein, one or more of these components may be part of or otherwise associated with a rendering system for rendering images. As a brief overview, the process 100 may include the statistics component 102 storing light sampling statistics 118 in the reservoir(s) 104. The light sampling statistics 118 may be determined by the statistics component 102 based on one or more light samples 120 corresponding to a previously rendered image/frame. The processing component 106 may update or modify the light sampling statistics 118 and provide the updated statistics to the global distribution component 108 and the local distribution component 110. The global distribution component 108 may use the light sampling statistics 118 and scene data 122 to generate a global sampling distribution 124 (e.g., an importance sampling distribution corresponding to the whole rendering frame/image). Additionally, the local distribution component 110 may use the light sampling statistics 118 to generate one or more local sampling distributions 126 (e.g., local importance sampling distributions corresponding to specific portions (e.g., pixel tiles) of the frame/image). The sampling component 112 may then use the scene data 122, the global sampling distribution 124, the local sampling distribution(s) 126, and/or one or more BSDF sampling distribution(s) 130 to generate the light sample(s) 120 corresponding to a current rendered image/frame. As shown, the statistics component 102 may use the light sample(s) 120 to determine and provide the light sampling statistics 118 for the next rendering frame/image. Additionally, the accumulation component 114 and the output component 116 may use the light sample(s) 120 from each rendering frame to generate image data 128 representing an image (e.g., the image for the current rendering frame).

In some examples—such as when the system(s) is rendering a first image of a series of images, when the scene or location in the virtual environment has changed and/or the light sources have changed, or any other scenarios—historical light sampling statistics 118 may not be available. In such scenarios, the system(s) may rely on BSDF sampling (e.g., the BSDF sampling distribution(s) 13) and/or the scene data 122 associated with the current rendering frame to sample the light sources in the scene. For instance, the global distribution component 108, the sampling component 112, and/or other components may use the scene data 122 to determine importance sampling distributions (e.g., based on the lights that are present or contributing to the scene), obtain the light sample(s) 120, and/or perform any other operations associated with rendering the first image. The scene data 122 may indicate various properties of the environment, such as the positions, intensities, and/or types of light sources, as well as the geometry, materials, and/or textures of objects or other surfaces within the scene. In some examples, the sampling component 112 may use the scene data 122 to accurately simulate the interactions between light rays and surfaces during the rendering process. For instance, the sampling component 112 may process the scene data 122 to, among other things, calculate how much light is emitted from each source, the paths that light rays take through the scene, and/or the materials'reflective or absorptive properties that affect how light contributes to the final image.

In some examples, the global distribution component 108 may use the scene data 122 to generate the global sampling distribution 124 based on the intensity (e.g., emissive flux) of the light sources within the scene. For instance, the global distribution component 108 may compute the weight of at least one light source (e.g., each light source in the virtual environment, each light source in the particular scene, etc.), which may define the light source's probability of being selected for sampling by the sampling component 112. In some instances, a light source's weight may be based on the light's emissive flux, with brighter lights receiving higher weights and dimmer lights receiving lower weights. Additionally, or alternatively, the global distribution component 108 may apply one or more custom modifiers to adjust these weights. For example, to reduce light sampling noise from lights that are near the camera, the global distribution component 108 may scale the weight by the inverse of the light's distance from the camera. In some examples, the global distribution component 108 may sum the weights of all the light sources and normalize these values such that the total probability of selecting any light equals one. As described in further detail herein, the per-light weights may be further modified or updated based on the light sampling statistics 118 from previous rendered frames, if available.

In some instances, as part of generating the global sampling distribution 124, the global distribution component 108 may compute a number of proxies for at least one (e.g., each) light source. In some examples, the number of proxies for a light may be proportional to the light's weight. The proxies may be pre-allocated and stored in a proxy table, with an entry of the proxy table containing the light's unique index and the corresponding number of proxies. This may allow for efficient management of light sampling during the rendering process. In some examples, the proxy table may be filled in a deterministic and unfragmented manner, which may improve temporal and spatial coherence. Additionally, in some instances, the global distribution component 108 may optionally sort the list of light sources included in the importance light sampling distribution by their Morton space-filling curve index, optimizing cache coherence and improving memory access patterns during sampling. This spatial sorting may also benefit low-discrepancy sampling by preserving the locality of light sources in image space, ensuring efficient sampling even in large and complex scenes.

In various examples, the sampling component 112 may generate the light sample(s) 120 using the global sampling distribution 124. That is, the sampling component 112 may sample the light sources in the scene based on their weights (e.g., intensity-based weights) in the global sampling distribution 124. By using the global sampling distribution 124, which may correspond to a intensity-based importance sampling distribution, rendering efficiency may be improved by prioritizing lights that contribute more significantly to illumination of the scene. This may reduce variance in Monte Carlo estimates by focusing the light sample(s) 120 on brighter or more influential light sources, leading to faster convergence and higher-quality results in global illumination computations. As described herein, the light sample(s) 120 may include, in some instances, NEE samples, Bidirectional Scattering Distribution Function (BSDF) samples, or any other kind of samples indicating which light sources are contributing to the illumination or shading of which surfaces in the virtual environment/scene that is to be depicted in the first image. For instance, the light sample(s) 120 may be generated or obtained using one or more light transport simulation techniques, such as ray tracing, path tracing, NEE path tracing, or any other kind of sampling. In some instances, the accumulation component 114 and/or the output component 116 may use the light sample(s) 120 for the current rendering frame to compute the final illumination values for each pixel in the image data 128, taking into account both direct and indirect lighting, material properties, and the geometry of the scene, to produce a realistic and high-quality render.

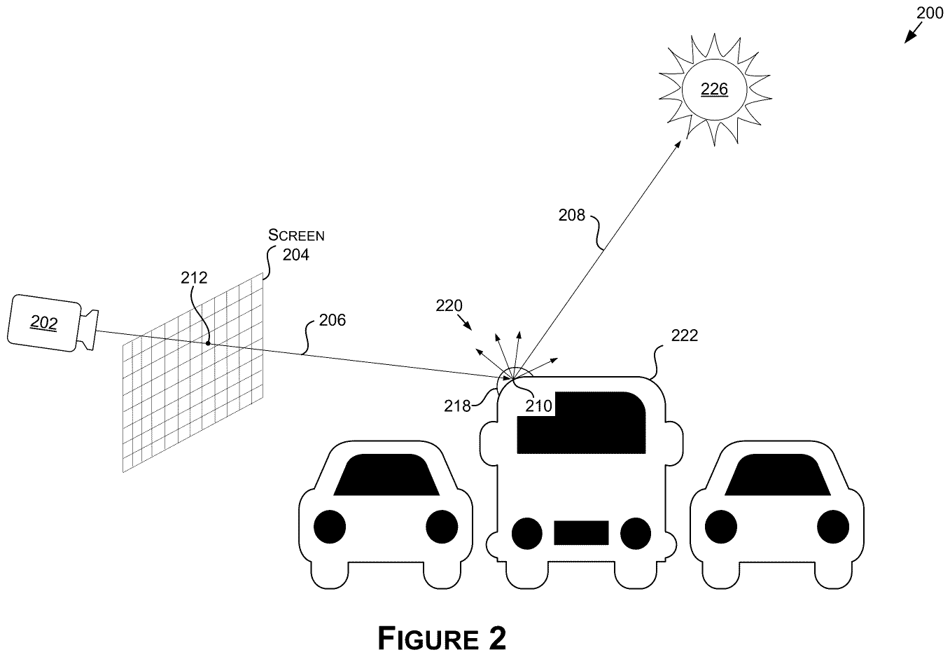

For instance, FIG. 2 illustrates an example of Path Tracing with Next Event Estimation, in accordance with some embodiments of the present disclosure. The path tracing operations described with respect to the example of FIG. 2 may be performed by, for instance, the sampling component 112 of FIG. 1 and/or any other components described herein for generating samples. FIG. 2 shows an environment 200 (e.g., a virtual environment), a camera 202, a screen 204, an object(s) 222, and a light source(s) 226.

The camera 202 may be a virtual camera, such as a viewpoint camera, and may represent a perspective of a viewer of the environment 200 to be rendered. The screen 204 may be a virtual representation of a screen which may or may not be the same resolution as the image represented by the image data 128, and/or other images generated in the rendering pipeline (e.g., the resolution may be converted, translated, or cropped). The screen 204 may include a matrix of virtual pixels or regions, of which a pixel 212 is individually labeled.

The sampling component 112 may use a similar or different approach for determining lighting condition data for each pixel of the screen 204 (e.g., path tracing, NEE, BSDF, etc.), an example of which is described with respect to the pixel 212. For example, a similar or different approach may be used for another pixel that involves a different light transport path. To determine at least some lighting condition data for the pixel 212 (e.g., corresponding to a pixel of the image data 128 of FIG. 1), the sampling component 112 may determine one or more ray-traced light transport paths through the environment 200. The ray 206 is an example of a ray of such a ray-traced light transport path for the pixel 212. In embodiments that only use one sample per-pixel to render the state of the virtual environment 200, such as to generate the image data 128, the light transport path may be the only path cast against the state and/or used to compute the lighting condition data for the pixel 212. Any number of light transport paths may be cast for a pixel and combined (e.g., using multiple importance sampling and/or other techniques) to determine the lighting condition data.

The light transport path(s) may be used to sample lighting conditions for the pixel 212. To do so, the sampling component 112 may cast any number of rays (e.g., one or more)—such as the ray 206—through the pixel 212 of the screen 204 to sample lighting conditions for the pixel 212. These rays may be referred to—for example and without limitation—as camera rays, eye rays, incident rays, view vectors, or primary rays, as examples. The sampling component 112 may use the camera rays to determine visible points in the environment 200. For example, the sampling component 112 may use the ray 206 to determine a point 210 on or near the surface of the object(s) 222. This may include the sampling component 112 determining the point 210 as a location where the ray 206 interacts (e.g., intersects) with the surface of the object(s) 222 (or the point 210 may otherwise be based at least in part on that location). Although the ray 206 interacts with the surface of the object(s) 222, in examples where more than one ray is cast, not all rays may interact with a surface, or may interact with a surface of another object (or no object).

From each point or interaction in the environment 200, any number of rays (e.g., one or more)—such as a ray 208—may be cast to determine the lighting contribution (e.g., irradiance) of the ray 206 at the point 210 or interaction. In some examples, one or more of these rays may be cast to simulate subsurface scattering within the object corresponding to the interaction. For example, subsurface scattering may be simulated to determine lighting data (e.g., representing lighting 218, such as irradiance) for the point 210 or interaction, which may form at least part of the lighting contribution for the pixel 212.

To simulate light behavior in the scene, the sampling component 112 may determine a direction of the directions 220 for the ray 208 and/or other rays based at least on sampling a distribution function. The distribution function may define a direction of one or more rays scattered from a location (e.g., the point 210) corresponding to the surface of the object 222. In one or more embodiments, the distribution function may be sampled using a stochastic sampling strategy, such as, for example and without limitation, a Monte Carlo or a quasi-Monte Carlo sampling strategy.

In one or more embodiments, the sampling strategy and direction may be based at least in part on a normal of the surface of the object 222 at the point 210. For example, the sampling component 112 may define a Normal Distribution Function (NDF) range for the point 210 based at least in part on the normal of the surface at the point 210. The sampling component 112 may use the NDF and the ray 206 (and in some examples a roughness value of the surface that is associated with the point 210 and/or other material properties) to define the distribution function. For example, the distribution function may include a bidirectional scattering distribution function (BSDF). The sampling component 112 may sample the distribution function (e.g., stochastically or using another sampling strategy) to determine the direction in which to cast the ray 208.

Additionally, or alternatively, the sampling component 112 may determine to sample the light source(s) 226 directly from the point 210 based on using NEE sampling. For instance, when the sampling component 112 is using NEE sampling, the sampling component 112 may determine to cast the ray 208 from the point 210 to the light source(s) 226, and then determine whether the light source(s) 226 is occluded or not. In such a scenario, the sampling component 112 may determine the contribution radiance of the light source(s) 226 to the pixel 212. That is, the sampling component 112 may, based on the sampling, determine the relative contribution of the light source(s) 226 to the radiance value of the pixel 212 in the image data 128.

Referring back to the example of FIG. 1, the process 100 may include the statistics component 102 receiving and using the light sample(s) 120 to determine the light sources that contributed the most to the illumination of different portions (e.g., pixels) of the scene corresponding to the image data 128. For instance, the statistics component 102 may generate the light sampling statistics 118 indicating the most influential light sources, and then store the light sampling statistics 118 in the reservoir(s) 104. The light sampling statistics 118 may then be obtained from the reservoir(s) during the next rendering frame to guide the generation of the global sampling distribution 124 and/or the local sampling distribution(s) 126.

In some examples, the statistics component 102 may obtain and process the light sample(s) 120 and determine feedback weights associated with each sample. For instance, the statistics component 102 may gather and process an image-space usage histogram to determine, for each pixel sample, a light index (e.g., identifier) corresponding to a selected light source and that light source's contribution to the pixel's radiance. In some examples, the radiance contribution for the image pixel being rendered may consist of direct emitter connections from the (e.g., main branch) path vertices and from NEE. In the case of NEE, the statistics component 102 may inherently know the index of the light that that has been sampled and whether that light has passed the segment visibility test. In the case of a path vertex landing on an emissive triangle, the statistics component 102 may know the light index corresponding to the emissive triangle (e.g., as it may be precomputed in a separate lookup table during light emitter precomputation). By knowing each contributing sample's light's index and its contribution radiance (which may inherently encode BSDF throughput, visibility, and/or selection probability), the statistics component 102 may create the light sampling statistics 118 to guide future NEE sampling, and help the global distribution component 108, the local distribution component 110, and/or the sampling component 112 find important light contributors more quickly.

In some instances, the statistics component 102 may calculate “feedback” weights for the light sample(s) 120 (as distinguishable from each light's importance sampling distribution weight). The statistics component 102 may use the feedback weights for the samples/lights as part of weighted reservoir sampling to store the most important contributing light sources for each image pixel, which may then be provided back to the algorithm in the next rendering frame for generating the importance sampling distributions (e.g., the global sampling distribution and the local sampling distribution(s) 126). In the case of NEE samples, the feedback weight may be based on the luminance of the input radiance, which may represent the perceived brightness of the light contributed by the sampled source (e.g., calculated as the max3 value of the RGB components). This radiance value may already be adjusted by dividing it by the total probability density as part of a Monte Carlo integration process. On the other hand, if the segment fails the visibility test, the weight may be set to zero.

In at least one example, the feedback weight may be multiplied by the light selection probability to the power of α, where 0.05≤α≤0.5, which may help avoid unwanted hysteresis. Additionally, or alternatively, the statistics component 102 may use a non-zero weight multiplier β (β≤0.1) to include currently shadowed lights, which may be beneficial in dynamic scenarios when shadowing changes from frame to frame.

As mentioned above and described herein, to optimize the usage of computational and storage resources, the image rendering system may, in some instances, use weighted reservoir sampling to keep track of a subset (e.g., one or more) of the most important contributing light sources per image pixel, instead of tracking or storing all of the light sample(s) 120 from NEE, BSDF, etc. For example, the reservoir(s) 104 may include per-pixel reservoirs (e.g., data structures) to store historic light sampling statistics 118 indicating relative contributions of the light sources to the radiance values of each pixel in the most recently rendered image and/or one or more previously rendered images. In some instances, each one of the reservoir(s) 104 may store a light index (e.g., identifier) corresponding to a sampled light source that contributed to the radiance value of a certain pixel in the image data 128, the feedback weight associated with that sampled light source, and the total weights of all the sampled light sources that contributed to the radiance of that certain pixel. In some examples, one or multiple of the reservoir(s) 104 may be stored for each pixel of the image data 128 (e.g., 1-4 reservoirs per pixel), and each reservoir may ultimately yield a single light index, that light index's feedback weight, and the total weight of all candidate lights considered for that pixel.

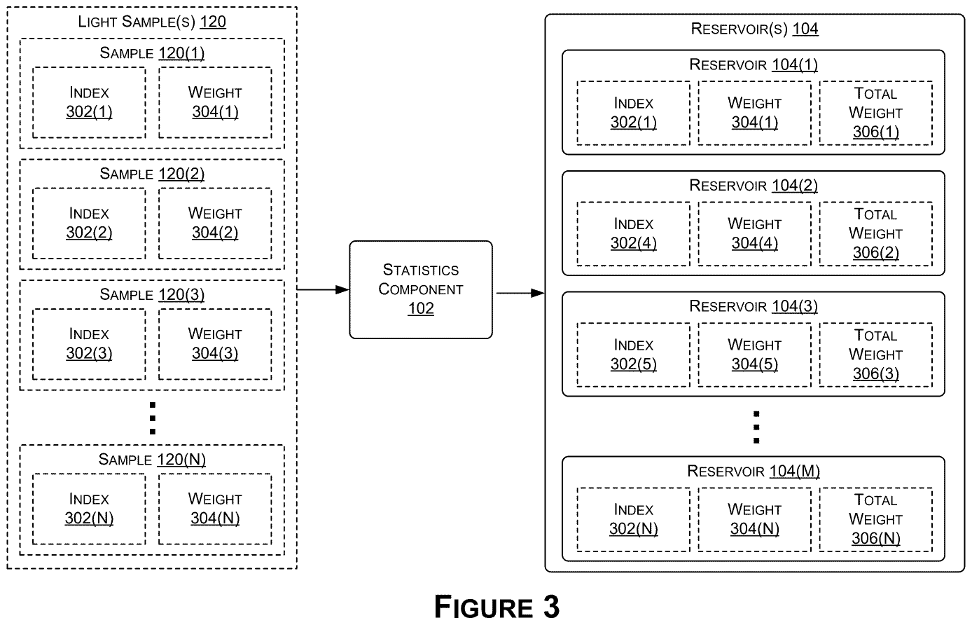

For instance, FIG. 3 is a data flow diagram illustrating an example of storing per-pixel light sampling statistics in image space reservoirs, in accordance with some embodiments of the present disclosure. As shown, the statistics component 102 may receive or otherwise obtain the light sample(s) 120. The light sample(s) 120 may include the samples 120(1)-120(N) (where “N” may represent any number of the samples 120). For explanatory purposes, the samples 120(1)-120(N) may each correspond to the same pixel of the image data 128. However, in some examples, the light sample(s) 120 may include samples for other pixels (e.g., each pixel, multiple pixels, etc.) of the image data 128. As shown, each of the samples 120(1)-120(N) may include an index 302 value identifying a specific light source and a weight 304 value indicating the light source's weight (e.g., contribution radiance to the pixel). For instance, the first sample 120(1) may include a first index 302(1) and a first weight 304(1), the second sample 120(2) may include a second index 302(2) and a second weight 304(2), the third sample 120(3) may include a third index 302(3) and a third weight 304(3), and so forth.

Using weighted reservoir sampling, the statistics component 102 may store the highest contributing light sources per image pixel in the reservoir(s) 104, where each one of the reservoirs 104(1)-104(M) (where “M” may represent any number of the reservoirs 104) may correspond to a specific pixel of the image data 128. For explanatory purposes, and not limitation, the first reservoir 104(1) may correspond to the same pixel of the image data 128 that the samples 120(1)-120(N) each correspond to, while the second reservoir 104(2), the third reservoir 104(3), and so forth may each correspond to other pixels of the image data 128. As shown, based on weighted reservoir sampling, the statistics component 102 may store light usage statistics for the pixels in the reservoirs 104(1)-104(M). For instance, based on the first weight 304(1) of the first sample 120(1) being greater than the second weight 304(2) of the second sample 120(2), the third weight 304(3) of the third sample 120(3), and so forth, the statistics component 102 may store the first index 302(1) and the first weight 304(1) of the first sample 120(1) in the first reservoir 104(1). In examples, the first total weight 306(1) stored in the first reservoir 104(1) may be equal to the sum of the first weight 304(1), the second weight 304(2), the third weight 304(3), and the Nth weight 304(N).

Additionally, statistics component 102 may use weight reservoir sampling to determine to store a fourth index 302(4) identifying a fourth light source, a fourth weight 304(4) of the fourth light source, and a second total weight 306(2) in the second reservoir 104(2) (e.g., which may correspond to a second pixel of the image data 128), determine to store a fifth index 302(5) identifying a fifth light source, a fifth weight 304(5) for the fifth light source, and a third total weight 306(3) in the third reservoir 104(3) (e.g., which may correspond to the third pixel and/or another pixel of the image data 128), as well as determine to store an Nth index 302(N), an Nth weight 304(N), and an Nth total weight 306(N) in the Mth reservoir 104(M).

In some instances, the different reservoirs 104(1)-104(M) may all correspond to the same pixel of the image and be used to store different parts of the sampled paths. For instance, the first reservoir 104(1) and the second reservoir 104(2) may be used to store statistics for more specular/direct parts of the path, while the third reservoir 104(3) and the Mth reservoir 104(M) may be used to store statistics for more diffuse parts of the path. In such instances, the statistics component 102 may begin by initially filling the first and second reservoir(s), handling light contributions with more specular or direct characteristics. As the path continues to bounce, the statistics component 102 may evaluate the path's scattering properties and, when it determines that the path has become predominantly diffuse (or diffuse by more than a threshold), the statistics component 102 may switch contributions to the third and Mth reservoir(s). This approach may enable more effective sampling and storage tailored to the lighting characteristics of different path segments.

In some examples, the reservoirs 104(1)-104(M) may be stored in 12 bytes of memory. For instance, the indexes 302, weights 304, and total weights 306 may each be 4-byte values. Additionally, or alternatively, to further save on memory, the statistics component 102 may store the index weights 304 and the total weights 306 as 16-bit floats (e.g., using a half-precision floating-point format). The values stored in the reservoirs 104(1)-104(M), in some instances, may be required only during the path tracing process and therefore may not need to be allocated in VRAM. Instead, these values may reside in GPU registers or temporary thread-local memory, enabling faster access and reduced memory overhead. In at least one example, in addition to providing feedback from NEE light sampling, the statistics component 102 may also provide feedback from the main path when it encounters emissive geometry or ends sampling on the environment map.

Referring back now to the example of FIG. 1, the process 100 may include the processing component 106 processing the light sampling statistics 118 stored in the reservoir(s) 104. For instance, the processing component 106 may process (e.g., pre-process and/or post-process) the light sampling statistics 118 to update or modify the information and make it more useful for the current/next (e.g., second) rendering frame. In some examples, light list (e.g., sampling distribution) may change between frames as light emitters get added and/or removed dynamically. As such, the processing component 106 may use one or more functions to maps light indices from the previous frame to the current frame. In some instances, if none of the light indices have changed, then this step may be skipped. Additionally, in some examples, some pixels may have no entry/statistics in the reservoir(s) 104, or the mappings to historical indices may be unavailable (e.g., such as when the light was deleted). In such instances, the processing component 106 may search neighboring pixels (e.g., immediate left/up/right/down) and, if valid, adopt their value for the pixels having no statistics. Additionally, or alternatively, if no valid entries exist, the processing component 106 may draw a random sample from the global sampling distribution 124.

In some examples, the processing component 106 may also account for camera and/or scene motion and enable guidance data reuse between frames. For instance, the processing component 106 may use Temporal Anti-Aliasing (TAA) and motion vectors to map pixel coordinates to their corresponding historic counterpart (e.g., reprojection). In some instances, such as when motion vectors are unavailable, the processing component 106 may use other techniques such as Fast Temporal Reprojection without Motion Vectors. In case of any disocclusions when motion vectors are unavailable, the processing component 106 may assume that motion vectors are (0, 0) and point to the same pixel, and/or assume an empty entry and re-sample from the global sampling distribution 124. To enable faster wide neighborhood sampling, the processing component 106 may create a representative lower resolution feedback reservoir (e.g., ⅓×⅓ or ¼×¼ resolution) using a form of down sampling. For instance, each lower resolution pixel's processing may start with an empty reservoir, and the processing component 106 may iterate through each of the higher resolution reservoir pixels in the image area covered by the lower resolution one, and stochastically insert its light index and weight into the reservoir.

In various examples, the process 100 may include the rendering system using the light sampling statistics 118 stored in the per-pixel reservoir(s) 104 to guide generation of light sampling distributions for the current/next rendering frame (e.g., the second image). For instance, the global distribution component 108 may use the light sampling statistics 118 (e.g., the processed statistics and/or unprocessed statistics) to generate/update the global sampling distribution 124 of the current (e.g., second) rendering frame. In some examples, to generate/update the global sampling distribution 124, the global distribution component 108 may initialize a buffer of unsigned integer counters for each light source and set each counter to zero. The global distribution component 108 may then evaluate the light sampling statistics 118 to determine the number of times each light source/index appears in the reservoir(s) 104. As an example, the global distribution component 108 may determine that a first number of the reservoir(s) 104 are storing a first index value corresponding to a first light source, a second number of the reservoir(s) 104 are storing a second index value corresponding to a second light source, a third number of the reservoir(s) 104 are storing a third index values corresponding to a third light source, and so forth. The global distribution component 108 may compute normalized per-light feedback weights based on the number of times each light source appears in the reservoir(s) 104, and use these normalized per-light feedback weights to update/modify the intensity-based per-light weights corresponding to the light sources included in the global sampling distribution 124. That is, the global distribution component 108 may initially use the scene data 122 for the current rendering frame to generate a intensity-based light importance sampling distribution, and then use the feedback weights from the light sampling statistics 118 to modify/update the weights of the lights in the intensity-based importance sampling distribution.

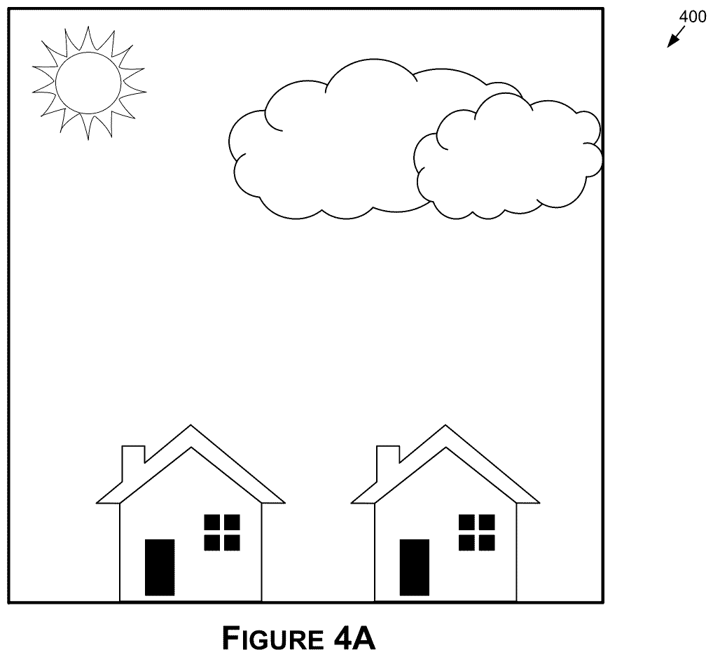

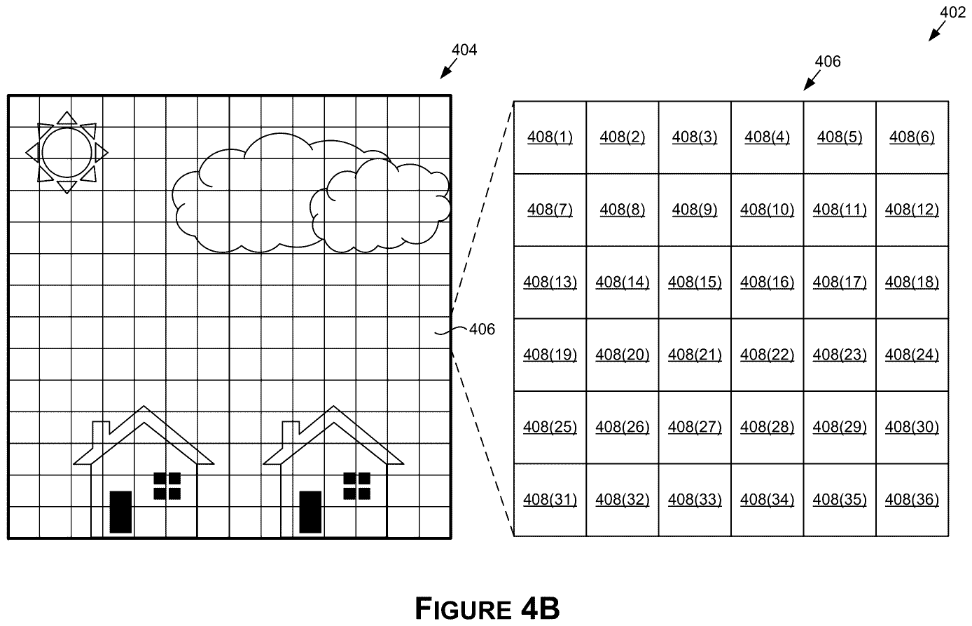

For instance, FIG. 4A illustrates an example 400 associated with a global light importance sampling distribution, in accordance with some embodiments of the present disclosure. In contrast to the local light importance sampling distribution of FIG. 4B, the global light importance sampling distribution may be determine based on the lights that contribute to the illumination of the current image and the previous image as a whole. For instance, the global sampling distribution may essentially include a ranked list of the light sources based on their contribution radiance to the current image and their contribution radiance to the previous image.

Referring back to the example of FIG. 1, the local distribution component 110 may also use the light sampling statistics 118 to generate the local sampling distribution(s) 126 for guiding the light importance sampling in the current (e.g., second) rendering frame. The local sampling distribution(s) 126 may be indicative of which lights in the virtual environment contributed most to illumination/pixel radiance for specific portions of the previously rendered image (e.g., locally relevant lights). For instance, to generate the local sampling distribution(s) 126, the local distribution component 110 may logically split the image/frame into a plurality of pixel tiles (e.g., 4×4 pixel tiles, 8×8 pixel tiles, 16×16 pixel tiles, 32×32 pixel tiles, etc.) and compute local, per-tile light importance sampling distributions. To do this, the local distribution component 110 may evaluate each tile individually to determine how many times each light index was listed as the highest contributing light source for each pixel. As an example, for a 4×4 pixel tile that includes 16 pixels, the local distribution component 110 may determine (based on the light sampling statistics 118) that a first light source was the highest contributor to radiance for 8 of the pixels, that a second light source was the highest contributor to radiance for 6 of the pixels, and that a third light source was the highest contributor to radiance for the remaining 2 of the pixels. The local distribution component 110 may then generate the local sampling distribution for this 4×4 pixel tile, with the light sources having weights proportional to the number of times each light was listed as the highest contributor to pixel radiance.

For instance, FIG. 4B illustrates an example 402 associated with a local light importance sampling distribution, in accordance with some embodiments of the present disclosure. As shown in the example 402, an image frame 404 may be logically split into a plurality of tiles (also referred to herein as “pixel tiles” or “portions”). In the example of FIG. 4B, the image frame 404 is split into 196 tiles, where each tile includes 36 pixels. For instance, a tile 406 of the image 404 includes 36 pixels 408(1)-408(36), as shown. However, this is just an example, and in additional or alternative examples the image frame 404 may be split into any number of tiles having any number of pixels (or resolution).

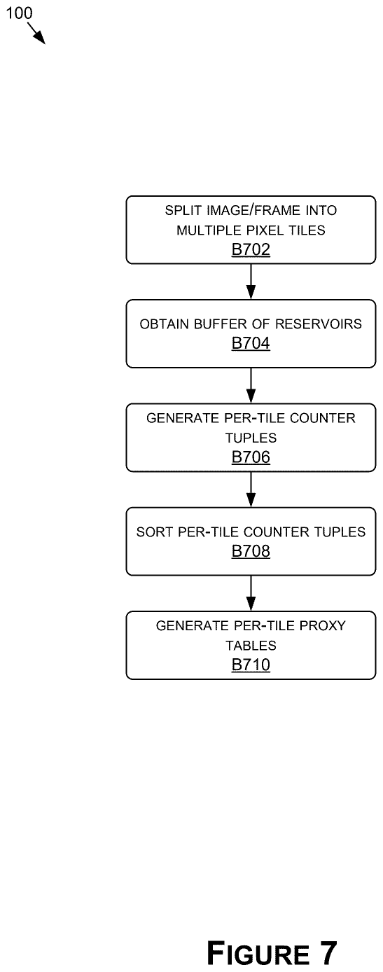

In some examples, the local distribution component 110 may determine a local sampling distribution 126 for each one of the tiles. For instance, the local distribution component 110 may determine a particular local sampling distribution corresponding to the tile 406 of the image 404. In such an example, the local sampling distribution for the tile 406 may be based on the lights of the previous image that contributed most to the radiance of each one of the pixels 408(1)-408(36). Additional information regarding how the local sampling distribution may be computed for each tile is described in greater detail below with respect to FIG. 7.

Referring back to the example of FIG. 1, the process 100 may include the rendering system using the global and local sampling distributions to guide the sampling of light sources in the scene for the second image. For instance, the sampling component 112 may use the global sampling distribution 124 and/or the local sampling distribution(s) 126 to generate the light sample(s) 120. In some examples, during light sampling in NEE, each path may have two light sampling distributions to pick from: the global sampling distribution 124 or the local sampling distribution(s) 126. In some instances, if the sampling component 112 samples from the global sampling distribution 124 alone, the rendered images may eventually converge to ground truth. In contrast, because the local sampling distribution(s) 126 may not cover all the light sources contributing to the frame, sampling from the local sampling distribution(s) 126 alone may not converge to the correct result. Thus, the sampling component 112 may be configured to sample from both of these distributions to get an unbiased result, while benefiting from locally adaptive sampling. To do this, in some instances, the sampling component 112 may use at least one sample from the global sampling distribution 124 and one or more samples from the local distribution(s) 126, and weigh the samples using multiple importance sampling with a balancing heuristic.

In some examples, to perform multiple importance sampling, the rendering system may compute a probability distribution function (PDF) for a given light sample in both the global and local sampling distributions. For instance, when drawing a light sample from the global sampling distribution 124, the sampling component 112 may search the corresponding local sampling distribution(s) 126 in order to find the light's multiple importance sampling weight. Similarly, when drawing a light sample from the local sampling distribution(s) 126, the sampling component 112 may obtain the light's selection probability in the global sampling distribution 124 at O(1) since the rendering system may store per-light proxy counters globally. In some examples, when used in conjunction with BSDF sampling in a path tracer, the rendering system may have a 3-way multiple importance sampling where one sample comes from BSDF, one sample comes from the global sampling distribution 124, and one sample comes from the local sampling distribution(s) 126. In such an example, if a sample is drawn from a first distribution, the sampling component 112 may be able to determine what the PDF is for the sample being drawn from the second and the third distributions, and compute weights for the sample.

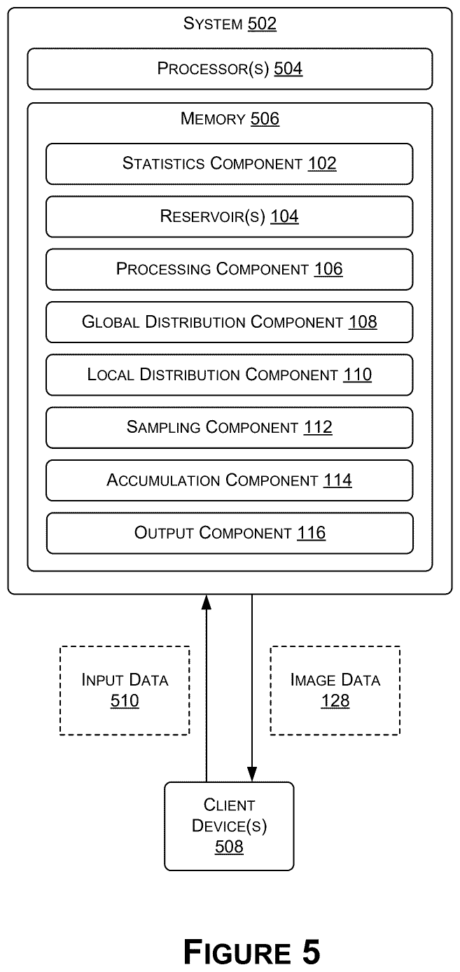

FIG. 5 illustrates an example of a system that may perform one or more of the processes described herein, in accordance with some embodiments of the present disclosure. As shown, the system 502 (which may represent, and/or include, the example computing device(s) 1700 and/or the example data center 1800) may include one or more processors 504 (which may be similar to, and/or include, the CPUs 1706 and/or the GPUs 1708) and memory 506 (which may be similar to, and/or include, the memory 1704). For instance, the memory 506 may store one or more of the statistics component 102, the reservoir(s) 104 (e.g., allocate storage space or buffers for the reservoir(s)), the processing component 106, the global distribution component 108, the local distribution component 110, the sampling component 112, the accumulation component 114, and/or the output component 116. Additionally, the processor(s) 504 may execute one or more of the statistics component 102, the reservoir(s) 104 (e.g., allocate storage space or buffers for the reservoir(s)), the processing component 106, the global distribution component 108, the local distribution component 110, the sampling component 112, the accumulation component 114, and/or the output component 116 to perform one or more of the processes described herein.

In some examples, the system 502 may communicate with one or more client devices 508 to cause presentation of images on the client device(s) 508. For instance, the system 502 may receive input data 510 (e.g., which may include scene data) from the client device(s) 508, and use the processor(s) 504 to execute one or more of the statistics component 102, the reservoir(s) 104 (e.g., allocate storage space or buffers for the reservoir(s)), the processing component 106, the global distribution component 108, the local distribution component 110, the sampling component 112, the accumulation component 114, and/or the output component 116 to generate and send the image data 128 back to the client device(s) 508.

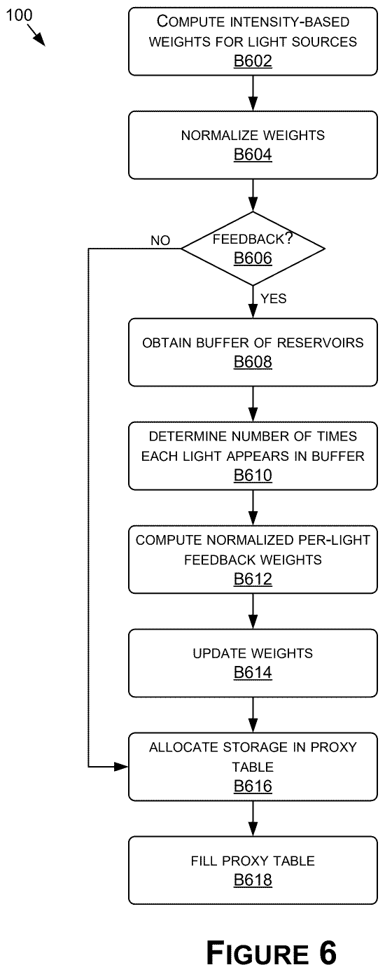

Now referring to FIGS. 6-10, each block of methods 600-1000, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 600-1000 are described, by way of example, with respect to the system of FIG. 1. However, these methods may additionally or alternatively be executed by any one system, or any combination of systems, including, but not limited to, those described herein.

FIG. 6 is a flow diagram illustrating an example of a method for generating a global light importance sampling distribution, in accordance with some embodiments of the present disclosure. The method 600, at block B602, includes computing intensity-based weights for light sources. For instance, the global distribution component 108 may compute each light's weight that may define the probability of the light being picked by importance sampling. In some examples, the weight for any given light source may correspond to, or be based on, that light's emissive flux. Additionally, or alternatively, the rendering system may apply any custom modifier at this point to compute the weight. For instance, if lower light sampling noise is desired for lights that are nearby the camera, the weight may be scaled by its inverse distance from the camera.

The method 600, at block B604, includes normalizing the intensity-based weights. For instance, the global distribution component 108 may normalize the intensity-based weights for the light sources. In some examples, this may include summing the weights of all the light sources and calculating the normalized weight for each light.

The method 600, at block B606, includes determining whether feedback of historic light usage statistics is available. For instance, the global distribution component 108 may determine whether the light sampling statistics 118 have been received. If the feedback statistics are available, the method 600 proceeds to block B608. However, if feedback statistics are not available, the method 600 proceeds to block B616.

The method 600, at block B608, includes obtaining a buffer of reservoirs. For instance, the global distribution component 108 may obtain the reservoir(s) 104 storing the per-pixel light sampling statistics 118 associated with the previous rendering frame/image.

The method 600, at block B610, includes determining a number of times each light appears in the buffer. For instance, the global distribution component 108 may initialize a buffer of counters (e.g., 32-bit unsigned integer counters) to zero, and count the number of times each light index appears in the feedback buffer/reservoirs. For instance, the global distribution component 108 may, for a (e.g., any, some, eac, etc.) pixel in the feedback image, use atomic increment (e.g., InterlockedAdd) on the corresponding light index to get the number of times each light appears in the feedback buffer.

The method 600, at block B612, includes computing normalized per-light feedback weights. For instance, the global distribution component 108 may compute the normalized per-light feedback weight Φ as the counter of block B610 divided by the total number of pixels in the feedback image and/or the total number of reservoirs (e.g., valid reservoirs, total reservoirs, etc.) in the feedback buffer.

The method 600, at block B614, includes updating the weights for the light sources. For instance, the weights of the light sources may be updated based on the normalized intensity-based weights and the normalized per-light feedback weights. As an example, the global distribution component 108 may calculate the final per-light weight as a combination of the baseline weight value B from intensity-based sampling (e.g., blocks B602 and B604), the feedback weight Φ, and interpolation factor γ where final weight Ω equals:

$$Ω = B ⋆ ( 1 - γ ) + Φ ⋆ γ$$

where γ may represent a user setting 0≥γ≥0.9.

The method 600, at block B616, includes allocating storage in a proxy table. For instance, the global distribution component 108 may compute the number of “proxies” needed for each light source and pre-allocate storage in the proxy table. In some examples, the number of proxies for any given light index may be proportional to that light's weight. Additionally, in some instances, each proxy entry in the proxy table may consist of the light's unique index and the number of occurrences of the light sample. In various examples, the data for each entry may, for example, be stored in two 32-bit unsigned integers.

The method 600, at block B618, includes filling the proxy table. For instance, the global distribution component 108 may fill in the proxy table. In some instances, the proxy table may be built in a deterministic and unfragmented way. As such, by building the proxy table in this way, temporal and spatial coherence may be improved, respectively, which may be important when using low discrepancy sampling.

FIG. 7 is a flow diagram illustrating an example of a method for generating local light importance sampling distributions, in accordance with some embodiments of the present disclosure. The method 700, at block B702, includes splitting the image/frame into multiple pixel tiles. For instance, the local distribution component 110 may split the image/frame into 8×8 pixel tiles (or anything from 4×4 to 32×32 or larger pixel tiles) to compute a plurality of local, per-tile light sampling distributions (e.g., the local sampling distribution(s) 126).

The method 700, at block B704, includes obtaining a buffer of reservoirs. For instance, the local distribution component 110 may obtain the reservoir(s) 104 storing the per-pixel light sampling statistics 118 associated with the previous rendering frame/image. In some examples, this may include the local distribution component 110 collecting all feedback light indices from the tile's 8×8 (or other dimension) block. Additionally, or alternatively, a larger window may be used to cover neighboring areas as well (e.g., a 12×12 block). In some instances, the local distribution component 110 may use the tile's 8×8 pixel block and the 8×8 pixel block from a lower resolution feedback (e.g., the down sampled image space light importance feedback, as described herein) centered around the tile and representative of a 24×24 high resolution area, for a total of 128 feedback samples. Additionally, or alternatively, the local distribution component 110 may use a certain number of samples from the rendering system's existing light culling approach, such as clustered shading, to help with providing the current frame's light selection and, in dynamic scenarios, reduce delays to finding the best lights. In some instances, local distribution component may generate a certain number of samples by doing a lower resolution path tracing with NEE pre-pass, which may help with providing the current frame's light selection and, in dynamic scenarios, reduce delays to finding the best lights.

The method 700, at block B706, includes generating per-tile counter tuples. For instance, the local distribution component 110 may, for each tile, initialize and maintain a list of counter tuples (e.g., [Light-Index, counter] tuples) with one entry for each unique light index in each tile, and the counter may reflect how many times that light index occurs within a specific tile. In at least one example, the local distribution component 110 may fill a list of light indices and local usage counter tuples, and then loop over all inputs from the feedback, searching for the existing index within the list. In case one with the same light index is found, the local distribution component 110 may increment the counter, otherwise if a new light index is found, the local distribution component may insert a new [Light Index, counter] tuple (with the counter set to 1) and repeat the process until all inputs have been added.

The method 700, at block B708, includes sorting the per-tile counter tuples. For instance, the local distribution component 110 may sort the per-tile counter tuples in order of incrementing light index values. This may allow for the binary searching for specific indices, which may also be needed and/or helpful for multiple importance sampling. Additionally, by sorting the tuples, the distribution may remain more stable between frames, providing more benefits from low discrepancy sampling, if used.

The method 700, at block B710, includes generating per-tile proxy tables. For instance, the local distribution component 110 may allocate storage in the per-tile proxy tables based on computing the number of “per-tile proxies” needed for each light source. In some examples, the number of per-tile proxies for any given light index may be proportional to that light's weight, which may correspond to how many times the light index was counted in each tile. The local distribution component 110 may also fill in the per-tile proxy tables.

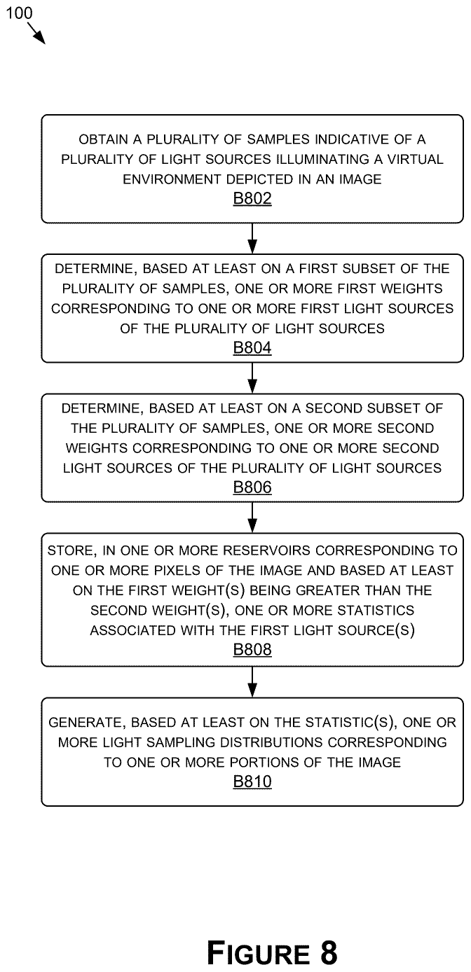

FIG. 8 is a flow diagram illustrating an example of a method for storing light sampling statistics in per-pixel reservoirs, in accordance with some embodiments of the present disclosure. The method 800, at block B802, includes obtaining a plurality of samples indicative of a plurality of light sources illuminating a virtual environment depicted in an image. For instance, the statistics component 102 may obtain the light sample(s) 120 indicative of the plurality of light sources illuminating the virtual environment depicted in the image represented using the image data 128.

The method 800, at block B804, includes determining, based at least on a first subset of the plurality of samples, one or more first weights corresponding to one or more first light sources of the plurality of light sources. For instance, the statistics component 102 may determine the first weights (e.g., feedback weights) corresponding to the first light source(s) based at least on the first subset of the light sample(s) 120.

The method 800, at block B806, includes determining, based at least on a second subset of the plurality of samples, one or more second weights corresponding to one or more second light sources of the plurality of light sources. For instance, the statistics component 102 may determine the second weights (e.g., feedback weights) corresponding to the second light source(s) based at least on the second subset of the light sample(s) 120.

The method 800, at block B808, includes storing, in one or more reservoirs corresponding to one or more pixels of the image and based at least on the first weight(s) being greater than the second weight(s), one or more statistics associated with the first light source(s). For instance, the statistics component 102 may use weighted reservoir sampling to determine to store the light sampling statistics 118 associated with the first light source(s) in the reservoir(s) 104, and the weighted reservoir sampling may automatically sort and store the statistics associated with the first light source(s) based at least on the first weight(s) being greater than the second weight(s)

The method 800, at block B810, includes generating, based at least on the statistic(s), one or more light sampling distributions corresponding to one or more portions of the image. For instance, the global distribution component 108 may generate the global sampling distribution 124 based at least on the light sampling statistics 118. Additionally, or alternatively, the local distribution component 110 may generate the local sampling distribution(s) 126 based at least on the light sampling statistics 118.

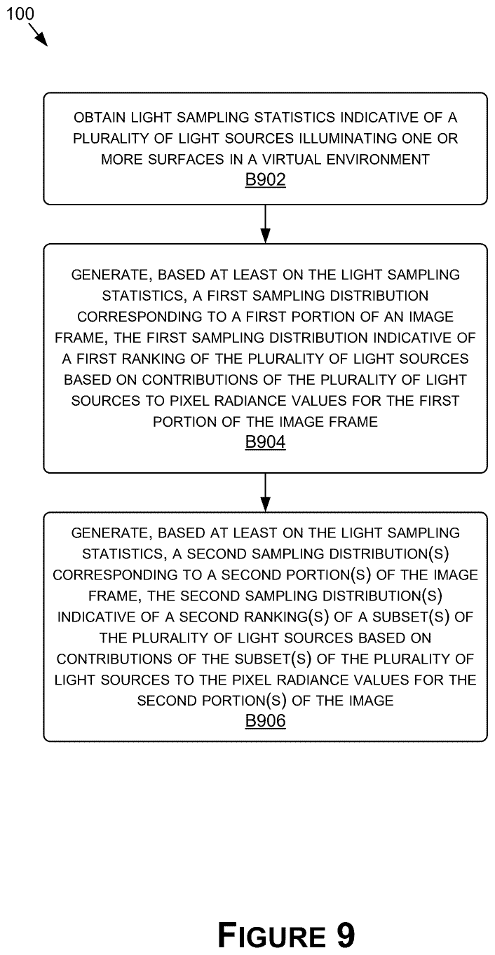

FIG. 9 is a flow diagram illustrating an example of a method for using light sampling statistics to generate global and local sampling distributions, in accordance with some embodiments of the present disclosure. The method 900, at block B902, includes obtaining light sampling statistics indicative of a plurality of light sources illuminating one or more surfaces in a virtual environment. For instance, the global distribution component 108 and the local distribution component 110 may obtain the light sampling statistics 118 indicative of the plurality of light sources illuminating the surface(s) in the virtual environment.

The method 900, at block B904, includes generating, based at least on the light sampling statistics, a first sampling distribution corresponding to a first portion of an image frame, the first sampling distribution indicative of a first ranking of the plurality of light sources based on contributions of the plurality of light sources to pixel radiance values for the first portion of the image frame. For instance, the global distribution component 108 of the rendering system may generate the global sampling distribution 124 based at least on the light sampling statistics 118. In some examples, the first portion may represent or correspond to the entire portion of the frame.

The method 900, at block B906, includes generating, based at least on the light sampling statistics, a second sampling distribution(s) corresponding to a second portion(s) of the image frame, the second sampling distribution(s) indicative of a second ranking(s) of a subset(s) of the plurality of light sources based on contributions of the subset(s) of the plurality of light sources to the pixel radiance values for the second portion(s) of the image. For instance, the local distribution component 110 may generate the local sampling distribution(s) 126 based at least on the light sampling statistics 118. In some examples, the second portion(s) of the image frame may represent or correspond to the plurality of pixel tiles within the frame.

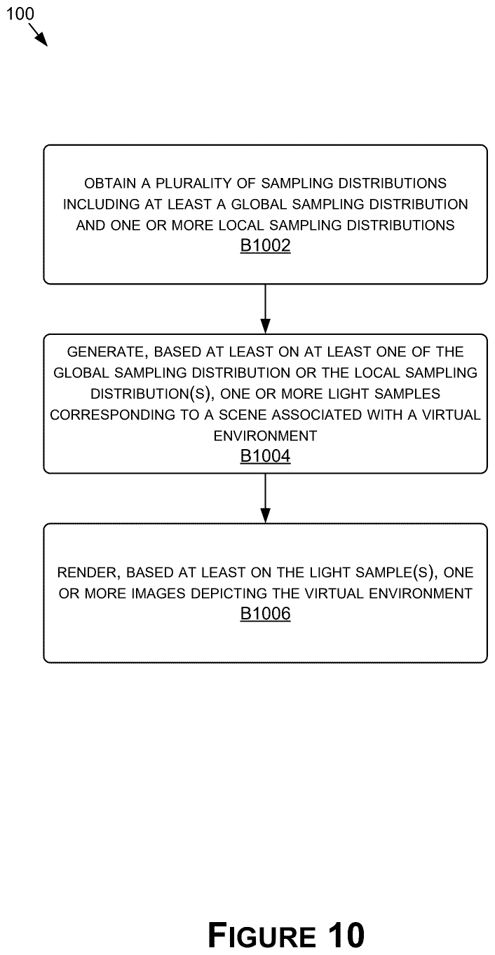

FIG. 10 is a flow diagram illustrating an example of a method for using global and local sampling distributions to guide future light sampling during the rendering of an image, in accordance with some embodiments of the present disclosure. The method 1000, at block B1002, includes obtaining a plurality of sampling distributions including at least a global sampling distribution and one or more local sampling distributions. For instance, the sampling component 112 may obtain the global sampling distribution 124 and the local sampling distribution(s) 126.

The method 1000, at block B1004, includes generating, based at least on at least one of the global sampling distribution or the local sampling distribution(s), one or more light samples corresponding to a scene associated with a virtual environment. For instance, the sampling component 112 may generate the light sample(s) corresponding to the scene based at least on sampling from at least one of the global sampling distribution 124 and/or the local sampling distribution(s) 126

The method 1000, at block B1006, includes rendering, based at least on the light sample(s), one or more images depicting the virtual environment. For instance, the accumulation component 114 may gather and combine data from the light sample(s) 120 and/or other samples, and the output component 116 may transform the accumulated data into the final image represented by the image data 128.

### Example Parallel Processing Architecture

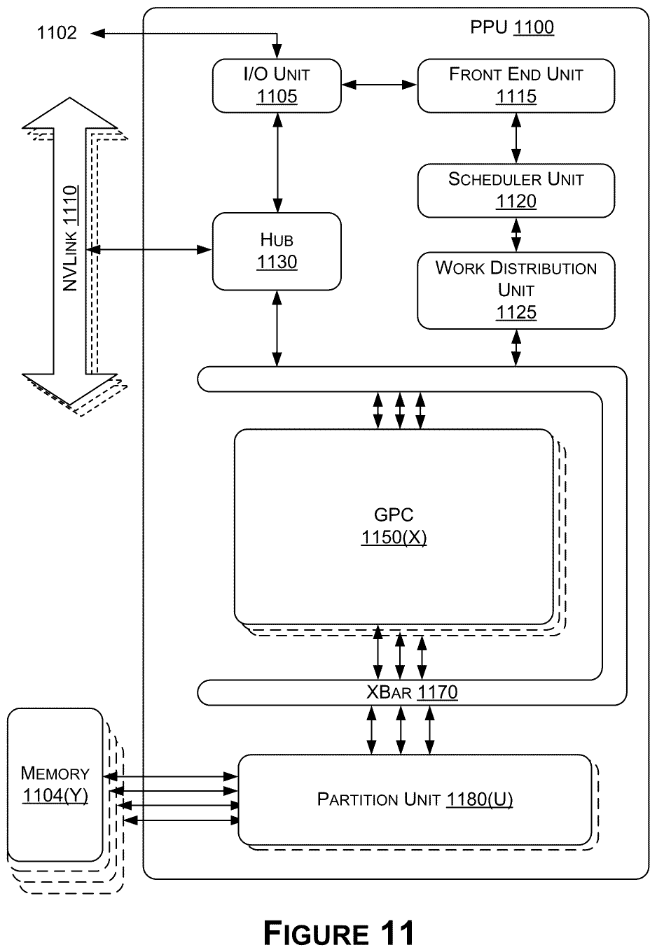

FIG. 11 illustrates an example parallel processing unit (PPU) 1100 suitable for use in implementing at least some embodiments of the present disclosure. In at least one embodiment, the PPU 1100 is a multi-threaded processor that is implemented on one or more integrated circuit devices. The PPU 1100 may have a latency hiding architecture designed to process many threads in parallel. A thread (e.g., a thread of execution) may refer to an instantiation of a set of instructions configured to be executed by the PPU 1100. In at least one embodiment, the PPU 1100 is a graphics processing unit (GPU) configured to implement a graphics rendering pipeline for processing three-dimensional (3D) graphics data in order to generate two-dimensional (2D) image data for display on a display device such as a liquid crystal display (LCD) device. In one or more embodiments, the PPU 1100 may be used for performing general-purpose computations. While one parallel processor is provided herein for illustrative purposes, it should be noted that such processor is set forth for illustrative purposes only, and that any processor may be employed to supplement and/or substitute for the same.

One or more PPUs 1100 may be configured to accelerate, by way of example and not limitation, thousands of High-Performance Computing (HPC), data center, and machine learning applications. The PPU 1100 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, light transport simulation, astronomy, molecular dynamics simulation, financial modeling, robotics, digital twinning, synthetic data generation, factory automation, real-time language translation, online search optimizations, personalized user recommendations, and the like.

As shown in FIG. 11, the PPU 1100 includes an Input/Output (I/O) unit 1105, a front end unit 1115, a scheduler unit 1120, a work distribution unit 1125, a hub 1130, a crossbar (Xbar) 1170, one or more general processing clusters (GPCs) 1150, and one or more partition units 1180. The PPU 1100 may be connected to a host processor or other PPUs 1100 via one or more high-speed NVLink 1110 interconnect. The PPU 1100 may be connected to a host processor or other peripheral devices via an interconnect 1102. The PPU 1100 may also be connected to a local memory comprising a number of memory devices 1104. In at least one embodiment, the local memory may comprise a number of dynamic random-access memory (DRAM) devices. The DRAM devices may be configured as a high-bandwidth memory (HBM) subsystem, with multiple DRAM dies stacked within each device.

The NVLink 1110 interconnect enables systems to scale and include one or more PPUs 1100 combined with one or more CPUs, supports cache coherence between the PPUs 1100 and CPUs, and CPU mastering. Data and/or commands may be transmitted by the NVLink 1110 through the hub 1130 to/from other units of the PPU 1100 such as one or more copy engines, a video encoder, a video decoder, a power management unit, etc. (not explicitly shown).

The I/O unit 1105 may be configured to transmit and receive communications (e.g., commands, data, etc.) from a host processor (not shown) over the interconnect 1102. The I/O unit 1105 may communicate with the host processor directly via the interconnect 1102 or through one or more intermediate devices such as a memory bridge. In at least one embodiment, the I/O unit 1105 may communicate with one or more other processors, such as one or more the PPUs 1100 via the interconnect 1102. In at least one embodiment, the I/O unit 1105 implements a Peripheral Component Interconnect Express (PCIe) interface for communications over a PCIe bus and the interconnect 1102 is a PCIe bus. In at least one embodiment, the I/O unit 1105 may implement other types of well-known interfaces for communicating with external devices.

The I/O unit 1105 decodes packets received via the interconnect 1102. In at least one embodiment, the packets represent commands configured to cause the PPU 1100 to perform various operations. The I/O unit 1105 transmits the decoded commands to various other units of the PPU 1100 as the commands may specify. For example, some commands may be transmitted to the front end unit 1115. Other commands may be transmitted to the hub 1130 or other units of the PPU 1100 such as one or more copy engines, a video encoder, a video decoder, a power management unit, etc. (not explicitly shown). In other words, the I/O unit 1105 may be configured to route communications between and among the various logical units of the PPU 1100.

In at least one embodiment, a program executed by the host processor encodes a command stream in a buffer that provides workloads to the PPU 1100 for processing. A workload may comprise several instructions and data to be processed by those instructions. The buffer may be a region in a memory that is accessible (e.g., read/write) by both the host processor and the PPU 1100. For example, the I/O unit 1105 may be configured to access the buffer in a system memory connected to the interconnect 1102 via memory requests transmitted over the interconnect 1102. In at least one embodiment, the host processor writes the command stream to the buffer and then transmits a pointer to the start of the command stream to the PPU 1100. The front end unit 1115 receives pointers to one or more command streams. The front end unit 1115 manages the one or more streams, reading commands from the streams and forwarding commands to the various units of the PPU 1100.

The front end unit 1115 is coupled to a scheduler unit 1120 that configures the various GPCs 1150 to process tasks defined by the one or more streams. The scheduler unit 1120 is configured to track state information related to the various tasks managed by the scheduler unit 1120. The state may indicate which GPC 1150 a task is assigned to, whether the task is active or inactive, a priority level associated with the task, and so forth. The scheduler unit 1120 manages the execution of a plurality of tasks on the one or more GPCs 1150.

The scheduler unit 1120 is coupled to a work distribution unit 1125 that is configured to dispatch tasks for execution on the GPCs 1150. The work distribution unit 1125 may track a number of scheduled tasks received from the scheduler unit 1120. In at least one embodiment, the work distribution unit 1125 manages a pending task pool and an active task pool for each of the GPCs 1150. The pending task pool may comprise a number of slots (e.g., 32 slots) that contain tasks assigned to be processed by a particular GPC 1150. The active task pool may comprise a number of slots (e.g., 4 slots) for tasks that are actively being processed by the GPCs 1150. As a GPC 1150 finishes the execution of a task, that task may be evicted from the active task pool for the GPC 1150 and one of the other tasks from the pending task pool is selected and scheduled for execution on the GPC 1150. If an active task has been idle on the GPC 1150, such as while waiting for a data dependency to be resolved, then the active task may be evicted from the GPC 1150 and returned to the pending task pool while another task in the pending task pool is selected and scheduled for execution on the GPC 1150.

The work distribution unit 1125 communicates with the one or more GPCs 1150 via XBar 1170. The XBar 1170 is an interconnect network that couples many of the units of the PPU 1100 to other units of the PPU 1100. For example, the XBar 1170 may be configured to couple the work distribution unit 1125 to a particular GPC 1150. Although not shown explicitly, one or more other units of the PPU 1100 may also be connected to the XBar 1170 via the hub 1130.

The tasks are managed by the scheduler unit 1120 and dispatched to a GPC 1150 by the work distribution unit 1125. The GPC 1150 is configured to process the task and generate results. The results may be consumed by other tasks within the GPC 1150, routed to a different GPC 1150 via the XBar 1170, or stored in the memory 1104. The results can be written to the memory 1104 via the partition units 1180, which may implement a memory interface for reading and writing data to/from the memory 1104. The results can be transmitted to another PPU 1100 or CPU via the NVLink 1110. In at least one embodiment, the PPU 1100 includes a number U of partition units 1180 that is equal to the number of separate and distinct memory devices 1104 coupled to the PPU 1100.

In at least one embodiment, a host processor executes a driver kernel that implements an application programming interface (API) that enables one or more applications executing on the host processor to schedule operations for execution on the PPU 1100. In at least one embodiment, multiple compute applications are simultaneously executed by the PPU 1100 and the PPU 1100 provides isolation, quality of service (QoS), and independent address spaces for the multiple compute applications. An application may generate instructions (e.g., API calls) that cause the driver kernel to generate one or more tasks for execution by the PPU 1100. The driver kernel may output tasks to one or more streams being processed by the PPU 1100. Each task may comprise one or more groups of related threads, wherein may be referred to as a warp. In at least one embodiment, a warp comprises 32 related threads that may be executed in parallel. Cooperating threads may refer to a plurality of threads including instructions to perform the task and that may exchange data through shared memory.

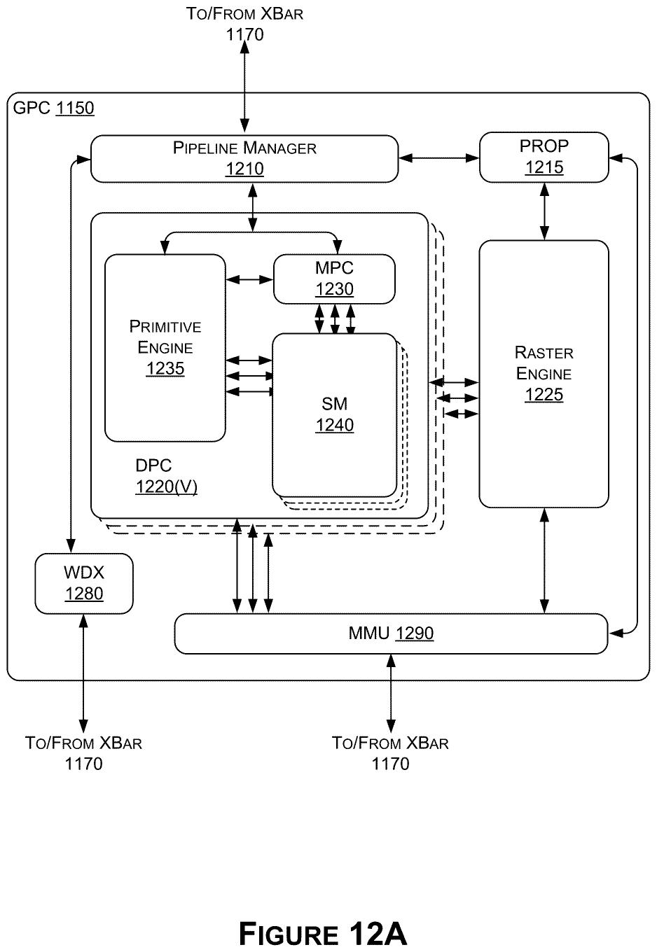

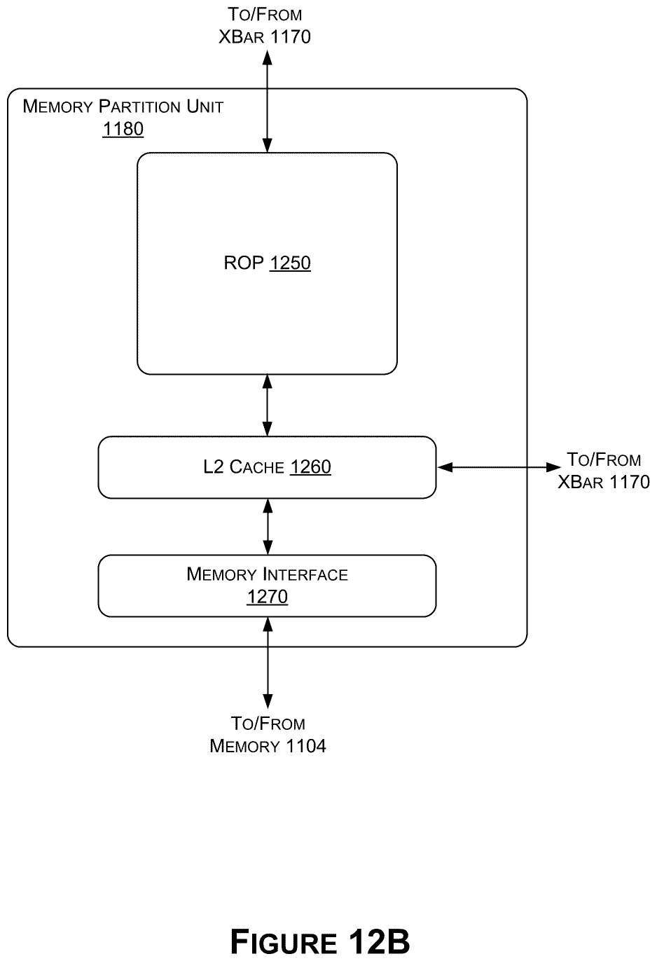

FIG. 12A illustrates an example GPC 1150 of the PPU 1100 of FIG. 11 suitable for use in implementing at least some embodiments of the present disclosure. As shown in FIG. 12A, each GPC 1150 may include a number of hardware units for processing tasks. In at least one embodiment, each GPC 1150 includes a pipeline manager 1210, a pre-raster operations unit (PROP) 1215, a raster engine 1225, a work distribution crossbar (WDX) 1280, a memory management unit (MMU) 1290, and one or more Data Processing Clusters (DPCs) 1220. It will be appreciated that the GPC 1150 of FIG. 12A may include other hardware units in lieu of or in addition to the units shown in FIG. 12A.

In at least one embodiment, the operation of the GPC 1150 is controlled by the pipeline manager 1210. The pipeline manager 1210 manages the configuration of the one or more DPCs 1220 for processing tasks allocated to the GPC 1150. In at least one embodiment, the pipeline manager 1210 may configure at least one of the one or more DPCs 1220 to implement at least a portion of a graphics rendering pipeline. For example, a DPC 1220 may be configured to execute a vertex shader program on the programmable streaming multiprocessor (SM) 1240. The pipeline manager 1210 may also be configured to route packets received from the work distribution unit 1125 to the appropriate logical units within the GPC 1150. For example, some packets may be routed to fixed function hardware units in the PROP 1215 and/or raster engine 1225 while other packets may be routed to the DPCs 1220 for processing by the primitive engine 1235 or the SM 1240. In at least one embodiment, the pipeline manager 1210 may configure at least one of the one or more DPCs 1220 to implement a neural network model and/or a computing pipeline.

The PROP unit 1215 may be configured to route data generated by the raster engine 1225 and the DPCs 1220 to a Raster Operations (ROP) unit. The PROP unit 1215 may also be configured to perform optimizations for color blending, organizing pixel data, performing address translations, and the like.

The raster engine 1225 may include a number of fixed function hardware units configured to perform various raster operations. In at least one embodiment, the raster engine 1225 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1225 comprises fragments to be processed, for example, by a fragment shader implemented within a DPC 1220.

Each DPC 1220 included in the GPC 1150 includes an M-Pipe Controller (MPC) 1230, a primitive engine 1235, and one or more SMs 1240. The MPC 1230 controls the operation of the DPC 1220, routing packets received from the pipeline manager 1210 to the appropriate units in the DPC 1220. For example, packets associated with a vertex may be routed to the primitive engine 1235, which is configured to fetch vertex attributes associated with the vertex from the memory 1104. In contrast, packets associated with a shader program may be transmitted to the SM 1240.

The SM 1240 comprises a programmable streaming processor that is configured to process tasks represented by a number of threads. Each SM 1240 is multi-threaded and configured to execute a plurality of threads (e.g., 32 threads) from a particular group of threads concurrently. In at least one embodiment, the SM 1240 implements a SIMD (Single-Instruction, Multiple-Data) architecture where each thread in a group of threads (e.g., a warp) is configured to process a different set of data based on the same set of instructions. All threads in the group of threads execute the same instructions. In at least one embodiment, the SM 1240 implements a SIMT (Single-Instruction, Multiple Thread) architecture where each thread in a group of threads is configured to process a different set of data based on the same set of instructions, but where individual threads in the group of threads are allowed to diverge during execution. In at least one embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

The MMU 1290 may provide an interface between the GPC 1150 and the partition unit 1180. The MMU 1290 may provide translation of virtual addresses into physical addresses, memory protection, and arbitration of memory requests. In at least one embodiment, the MMU 1290 provides one or more translation lookaside buffers (TLBs) for performing translation of virtual addresses into physical addresses in the memory 1104.

FIG. 12B illustrates an example memory partition unit 1180 of the PPU 1100 of FIG. 11 suitable for use in implementing at least some embodiments of the present disclosure. As shown in FIG. 12B, the memory partition unit 1180 includes a Raster Operations (ROP) unit 1250, a level two (L2) cache 1260, and a memory interface 1270. The memory interface 1270 may be coupled to the memory 1104. Memory interface 1270 may implement 32, 64, 128, 1024-bit data buses, or the like, for high-speed data transfer. In at least one embodiment, the PPU 1100 incorporates U memory interfaces 1270, one memory interface 1270 per pair of partition units 1180, where each pair of partition units 1180 is connected to a corresponding memory device 1104. For example, the PPU 1100 may be connected to up to Y memory devices 1104, such as high bandwidth memory stacks or graphics double-data-rate, version 5, synchronous dynamic random access memory, or other types of persistent storage.

In at least one embodiment, the memory interface 1270 implements an HBM2 memory interface and Y equals half U. In at least one embodiment, the HBM2 memory stacks are located on the same physical package as the PPU 1100, providing substantial power and area savings compared with conventional GDDR5 SDRAM systems. In at least one embodiment, each HBM2 stack includes four memory dies and Y equals 4, with HBM2 stack including two 128-bit channels per die for a total of 8 channels and a data bus width of 1024 bits.

In at least one embodiment, the memory 1104 supports Single-Error Correcting Double-Error Detecting (SECDED) Error Correction Code (ECC) to protect data. ECC provides high reliability for compute applications that are sensitive to data corruption. Reliability is especially important in large-scale cluster computing environments where the PPUs 1100 process very large datasets and/or run applications for extended periods.

In at least one embodiment, the PPU 1100 implements a multi-level memory hierarchy. In at least one embodiment, the memory partition unit 1180 supports a unified memory to provide a single unified virtual address space for CPU and PPU 1100 memory, enabling data sharing between virtual memory systems. In at least one embodiment the frequency of accesses by a PPU 1100 to memory located on other processors is traced to ensure that memory pages are moved to the physical memory of the PPU 1100 that is accessing the pages more frequently. In at least one embodiment, the NVLink 1110 supports address translation services allowing the PPU 1100 to directly access a CPU's page tables and providing full access to CPU memory by the PPU 1100.

In at least one embodiment, copy engines transfer data between multiple PPUs 1100 or between PPUs 1100 and CPUs. The copy engines can generate page faults for addresses that are not mapped into the page tables. The memory partition unit 1180 can then service the page faults, mapping the addresses into the page table, after which the copy engine can perform the transfer. With hardware page faulting, addresses can be passed to the copy engines without worrying if the memory pages are resident, and the copy process is transparent.

Data from the memory 1104 or other system memory may be fetched by the memory partition unit 1180 and stored in the L2 cache 1260, which is located on-chip and is shared between the various GPCs 1150. As shown, each memory partition unit 1180 includes a portion of the L2 cache 1260 associated with a corresponding memory device 1104. Lower level caches may then be implemented in various units within the GPCs 1150. For example, each of the SMs 1240 may implement a level one (L1) cache. The L1 cache is private memory that may be dedicated to a particular SM 1240. Data from the L2 cache 1260 may be fetched and stored in each of the L1 caches for processing in the functional units of the SMs 1240. The L2 cache 1260 is coupled to the memory interface 1270 and the XBar 1170.

The ROP unit 1250 performs graphics raster operations related to pixel color, such as color compression, pixel blending, and the like. The ROP unit 1250 also implements depth testing in conjunction with the raster engine 1225, receiving a depth for a sample location associated with a pixel fragment from the culling engine of the raster engine 1225. The depth is tested against a corresponding depth in a depth buffer for a sample location associated with the fragment. If the fragment passes the depth test for the sample location, then the ROP unit 1250 updates the depth buffer and transmits a result of the depth test to the raster engine 1225. It will be appreciated that the number of partition units 1180 may be different than the number of GPCs 1150 and, therefore, each ROP unit 1250 may be coupled to each of the GPCs 1150. The ROP unit 1250 may track packets received from the different GPCs 1150 and determine which GPC 1150 that a result generated by the ROP unit 1250 is routed to through the Xbar 1170. Although the ROP unit 1250 is included within the memory partition unit 1180 in FIG. 12B, in other examples, the ROP unit 1250 may be outside of the memory partition unit 1180. For example, the ROP unit 1250 may reside in the GPC 1150 or another unit.

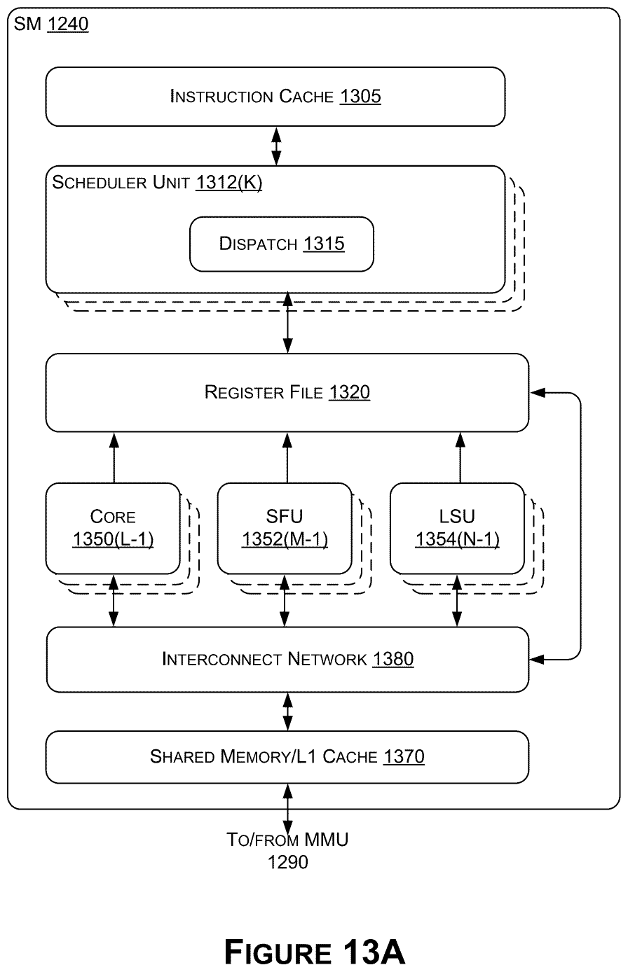

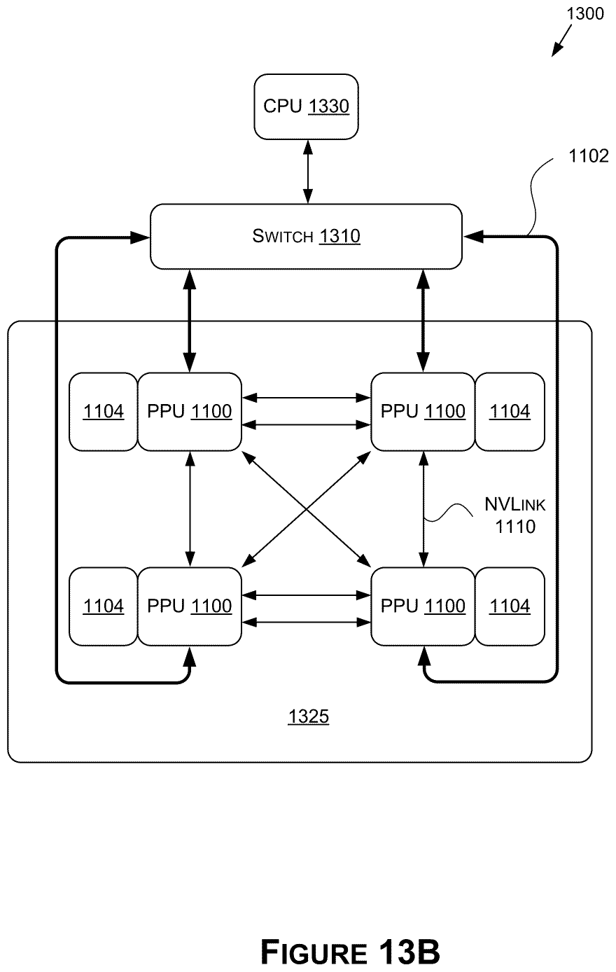

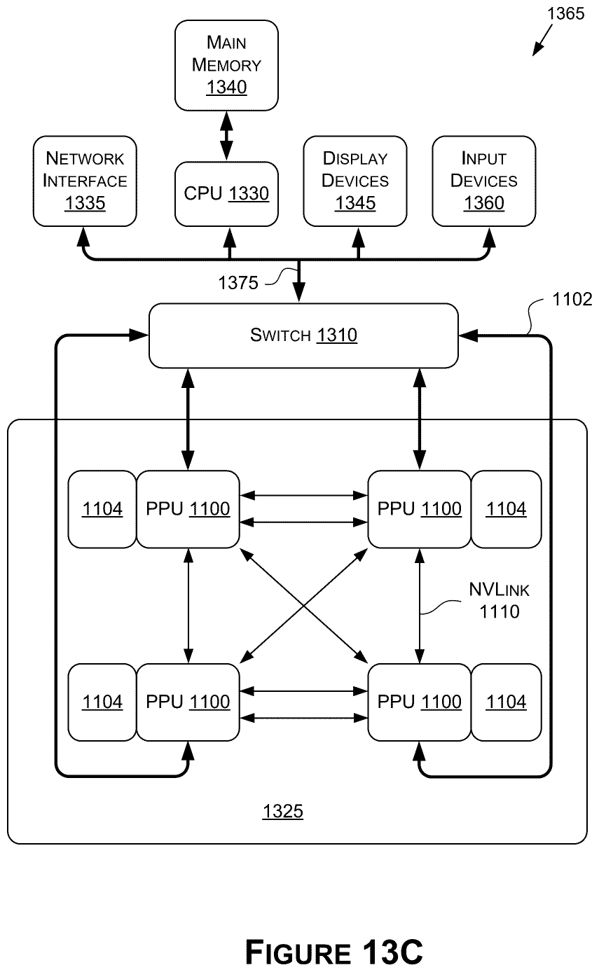

FIG. 13A illustrates an example of the streaming multi-processor 1240 of FIG. 12A suitable for use in implementing at least some embodiments of the present disclosure. As shown in FIG. 13A, the SM 1240 includes an instruction cache 1305, one or more scheduler units 1312, a register file 1320, one or more processing cores 1350, one or more special function units (SFUs) 1352, one or more load/store units (LSUs) 1354, an interconnect network 1380, and a shared memory/L1 cache 1370.

As described herein, the work distribution unit 1125 dispatches tasks for execution on the GPCs 1150 of the PPU 1100. The tasks may be allocated to a particular DPC 1220 within a GPC 1150 and, if the task is associated with a shader program, the task may be allocated to an SM 1240. The scheduler unit 1312 may receive the tasks from the work distribution unit 1125 and manage instruction scheduling for one or more thread blocks assigned to the SM 1240. The scheduler unit 1312 may schedule thread blocks for execution as warps of parallel threads, where each thread block is allocated at least one warp. In at least one embodiment, each warp executes 32 threads. The scheduler unit 1312 may manage a plurality of different thread blocks, allocating the warps to the different thread blocks and then dispatching instructions from the plurality of different cooperative groups to the various functional units (e.g., cores 1350, SFUs 1352, and LSUs 1354) during each clock cycle.

Cooperative Groups may refer to a programming model for organizing groups of communicating threads that allows developers to express the granularity at which threads are communicating, enabling the expression of richer, more efficient parallel decompositions. Cooperative launch APIs may support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 1315 may be configured to transmit instructions to one or more of the functional units. In at least one embodiment, the scheduler unit 1312 includes two dispatch units 1315 that enable two different instructions from the same warp to be dispatched during each clock cycle. In at least embodiment, each scheduler unit 1312 may include a single dispatch unit 1315 or additional dispatch units 1315.

Each SM 1240 may include a register file 1320 that provides a set of registers for the functional units of the SM 1240. In at least one embodiment, the register file 1320 is divided between each of the functional units such that each functional unit is allocated a dedicated portion of the register file 1320. In at least one embodiment, the register file 1320 is divided between the different warps being executed by the SM 1240. The register file 1320 provides temporary storage for operands connected to the data paths of the functional units.

Each SM 1240 may include L processing cores 1350. In at least one embodiment, the SM 1240 includes a large number (e.g., 128, etc.) of distinct processing cores 1350. Each core 1350 may include a fully-pipelined, single-precision, double-precision, and/or mixed precision processing unit that includes a floating point arithmetic logic unit and an integer arithmetic logic unit. In at least one embodiment, the floating point arithmetic logic units implement the IEEE 754-2008 standard for floating point arithmetic. In at least one embodiment, the cores 1350 include 64 single-precision (32-bit) floating point cores, 64 integer cores, 32 double-precision (64-bit) floating point cores, and 8 tensor cores.

Tensor cores configured to perform matrix operations, and, in at least one embodiment, one or more tensor cores are included in the cores 1350. In particular, the tensor cores may be configured to perform deep learning matrix arithmetic, such as convolution operations for neural network training and inferencing. In at least one embodiment, each tensor core operates on a 4×4 matrix and performs a matrix multiply and accumulate operation D=A×B+C, where A, B, C, and D are 4×4 matrices.

Training complex neural networks requires massive amounts of parallel computing performance, including floating-point multiplications and additions that are supported by the PPU 1100. Inferencing is less compute-intensive than training, being a latency-sensitive process where a trained neural network is applied to new inputs it has not seen before to classify images, translate speech, and infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 1100 may form a computing platform capable of delivering performance required for deep neural network-based artificial intelligence and machine learning applications.

In at least one embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores may be used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 1240 may also include M SFUs 1352 that perform special functions (e.g., attribute evaluation, reciprocal square root, and the like). In at least one embodiment, the SFUs 1352 may include a tree traversal unit configured to traverse a hierarchical tree data structure. In at least one embodiment, the SFUs 1352 may include texture unit configured to perform texture map filtering operations. In at least one embodiment, the texture units are configured to load texture maps (e.g., a 2D array of texels) from the memory 1104 and sample the texture maps to produce sampled texture values for use in shader programs executed by the SM 1240. In at least one embodiment, the texture maps are stored in the shared memory/L1 cache 1270. The texture units implement texture operations such as filtering operations using mip-maps (e.g., texture maps of varying levels of detail). In at least one embodiment, each SM 1240 includes two texture units.

Each SM 1240 may also include N LSUs 1354 that implement load and store operations between the shared memory/L1 cache 1370 and the register file 1320. Each SM 1240 may include an interconnect network 1380 that connects each of the functional units to the register file 1320 and the LSU 1354 to the register file 1320, shared memory/L1 cache 1370. In at least one embodiment, the interconnect network 1380 is a crossbar that can be configured to connect any of the functional units to any of the registers in the register file 1320 and connect the LSUs 1354 to the register file and memory locations in shared memory/L1 cache 1370.

The shared memory/L1 cache 1370 may include an array of on-chip memory that allows for data storage and communication between the SM 1240 and the primitive engine 1235 and between threads in the SM 1240. In at least one embodiment, the shared memory/L1 cache 1370 comprises 128 KB of storage capacity and is in the path from the SM 1240 to the partition unit 1180. The shared memory/L1 cache 1370 can be used to cache reads and writes. One or more of the shared memory/L1 cache 1370, L2 cache 1260, and memory 1104 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations can use the remaining capacity. Integration within the shared memory/L1 cache 1370 may enable the shared memory/L1 cache 1370 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 11, may be bypassed, creating a much simpler programming model. In the general-purpose parallel computation configuration, the work distribution unit 1125 may assign and distribute blocks of threads directly to the DPCs 1220. The threads in a block may execute the same program, using a unique thread ID in the calculation to ensure each thread generates unique results, using the SM 1240 to execute the program and perform calculations, shared memory/L1 cache 1370 to communicate between threads, and the LSU 1354 to read and write global memory through the shared memory/L1 cache 1370 and the memory partition unit 1180. When configured for general purpose parallel computation, the SM 1240 can also write commands that the scheduler unit 1120 can use to launch new work on the DPCs 1220.

The PPU 1100 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In at least one embodiment, the PPU 1100 is embodied on a single semiconductor substrate. In at least one embodiment, the PPU 1100 is included in a system-on-a-chip (SoC) along with one or more other devices such as additional PPUs 1100, the memory, a reduced instruction set computer (RISC) CPU, a memory management unit (MMU), a digital-to-analog converter (DAC), and the like.

In at least one embodiment, the PPU 1100 may be included on a graphics card that includes one or more memory devices 1104. The graphics card may be configured to interface with a PCIe slot on a motherboard of a desktop computer. In at least one embodiment, the PPU 1100 may be an integrated graphics processing unit (iGPU) or parallel processor included in the chipset of the motherboard.

### Example of a Computing System

Systems with multiple GPUs and CPUs are used in a variety of industries as developers expose and use more parallelism in applications such as artificial intelligence computing. High-performance GPU-accelerated systems with tens to many thousands or more of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13B is an example conceptual diagram of a processing system 1300 implemented using the PPU 1100 of FIG. 11 suitable for use in implementing at least some embodiments of the present disclosure. The processing system 1300 includes a CPU 1330, switch 1310, and multiple PPUs 1100 each and respective memories 1104. The NVLink 1110 provides high-speed communication links between each of the PPUs 1100. Although a particular number of NVLink 1110 and interconnect 1102 connections are illustrated in FIG. 13B, the number of connections to each PPU 1100 and the CPU 1330 may vary. The switch 1310 interfaces between the interconnect 1102 and the CPU 1330. The PPUs 1100, memories 1104, and NVLinks 1110 may be situated on a single semiconductor platform to form a parallel processing system 1325. In at least one embodiment, the switch 1310 supports two or more protocols to interface between various different connections and/or links.

In at least embodiment (not shown), the NVLink 1110 provides one or more high-speed communication links between each of the PPUs 1100 and the CPU 1330 and the switch 1310 interfaces between the interconnect 1102 and each of the PPUs 1100. The PPUs 1100, memories 1104, and interconnect 1102 may be situated on a single semiconductor platform to form a parallel processing module 1325. In at least one embodiment (not shown), the interconnect 1102 provides one or more communication links between each of the PPUs 1100 and the CPU 1330 and the switch 1310 interfaces between each of the PPUs 1100 using the NVLink 1110 to provide one or more high-speed communication links between the PPUs 1100. In at least one embodiment (not shown), the NVLink 1110 provides one or more high-speed communication links between the PPUs 1100 and the CPU 1330 through the switch 1310. In yet at least one embodiment (not shown), the interconnect 1102 provides one or more communication links between each of the PPUs 1100 directly. One or more of the NVLink 1110 high-speed communication links may be implemented as a physical NVLink interconnect or either an on-chip or on-die interconnect using the same protocol as the NVLink 1110.

In the context of the present description, a single semiconductor platform may refer to a sole unitary semiconductor-based integrated circuit fabricated on a die or chip. The term single semiconductor platform may also refer to multi-chip modules with increased connectivity which simulate on-chip operation and make substantial improvements over using a conventional bus implementation. Of course, the various circuits or devices may also be situated separately or in various combinations of semiconductor platforms per the desires of the user. Alternately, the parallel processing module 1325 may be implemented as a circuit board substrate and each of the PPUs 1100 and/or memories 1104 may be packaged devices. In at least one embodiment, the CPU 1330, switch 1310, and the parallel processing module 1325 are situated on a single semiconductor platform.

In at least one embodiment, the signaling rate of each NVLink 1110 is 20 to 25 Gigabits/second and each PPU 1100 includes six NVLink 1110 interfaces (as shown in FIG. 13B, five NVLink 1110 interfaces are included for each PPU 1100). Each NVLink 1110 may provide a data transfer rate of 25 Gigabytes/second in each direction, with six links providing 1100 Gigabytes/second. The NVLinks 1110 can be used exclusively for PPU-to-PPU communication as shown in FIG. 13B, or some combination of PPU-to-PPU and PPU-to-CPU, when the CPU 1330 also includes one or more NVLink 1110 interfaces.

In at least one embodiment, the NVLink 1110 allows direct load/store/atomic access from the CPU 1330 to each PPU's 1100 memory 1104. In at least one embodiment, the NVLink 1110 supports coherency operations, allowing data read from the memories 1104 to be stored in the cache hierarchy of the CPU 1330, reducing cache access latency for the CPU 1330. In at least one embodiment, the NVLink 1110 includes support for Address Translation Services (ATS), allowing the PPU 1100 to directly access page tables within the CPU 1330. One or more of the NVLinks 1110 may also be configured to operate in a low-power mode.

FIG. 13C illustrates an example system 1365 in which the various architecture and/or functionality of the various previous embodiments may be implemented suitable for use in implementing at least some embodiments of the present disclosure.

As shown, a system 1365 is provided including at least one central processing unit 1330 that is connected to a communication bus 1375. The communication bus 1375 may be implemented using any suitable protocol, such as PCI (Peripheral Component Interconnect), PCI-Express, AGP (Accelerated Graphics Port), HyperTransport, or any other bus or point-to-point communication protocol(s). The system 1365 also includes a main memory 1340. Control logic (software) and data are stored in the main memory 1340 which may take the form of random access memory (RAM).

The system 1365 also includes input devices 1360, the parallel processing system 1325, and display devices 1345, e.g. a conventional CRT (cathode ray tube), LCD (liquid crystal display), LED (light emitting diode), plasma display or the like. User input may be received from the input devices 1360, e.g., keyboard, mouse, touchpad, microphone, and the like. Each of the foregoing modules and/or devices may even be situated on a single semiconductor platform to form the system 1365. Alternately, the various modules may also be situated separately or in various combinations of semiconductor platforms per the desires of the user.

Further, the system 1365 may be coupled to a network (e.g., a telecommunications network, local area network (LAN), wireless network, wide area network (WAN) such as the Internet, peer-to-peer network, cable network, or the like) through a network interface 1335 for communication purposes.

The system 1365 may also include a secondary storage (not shown). The secondary storage may include, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive may read from and/or writes to a removable storage unit.

Computer programs, or computer control logic algorithms, may be stored in the main memory 1340 and/or the secondary storage. Such computer programs, when executed, enable the system 1365 to perform various functions. The memory 1340, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1365 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

### Ray Tracing Pipeline

In at least one embodiment, the PPU 1100 comprises a graphics processing unit (GPU). The PPU 1100 may be configured to receive commands that specify shader programs for processing graphics data. Graphics data may be defined as a set of primitives such as points, lines, triangles, quads, triangle strips, and the like. A primitive may include data that specifies a number of vertices for the primitive (e.g., in a model-space coordinate system) as well as attributes associated with each vertex of the primitive. The PPU 1100 may be configured to process the graphics primitives to generate a frame buffer (e.g., pixel data for each of the pixels of the display).

An application may write model data for a scene (e.g., a collection of vertices and attributes) to a memory such as a system memory or memory 1104. The model data may define each of the objects that may be visible on a display. The application may then make an API call to the driver kernel that requests the model data to be rendered and displayed. The driver kernel may read the model data and write commands to the one or more streams to perform operations to process the model data. The commands may reference different shader programs to be implemented on the SMs 1240 of the PPU 1100. For example, different SMs 1240 may be configured to execute different shader programs.

In at least one embodiment, the model data may be processed to perform one or more ray tracing operations, such as real-time tray tracing, to render the model data to a frame buffer. The contents of the frame buffer may be transmitted to a display controller for display on a display device. Ray tracing may refer to any of a variety of techniques for modeling or simulating light transport and/or other aspects of an environment, for example, for use in generating digital images or otherwise simulating the environment. Thus, while certain embodiments may be described with respect to light transport simulation, they may be applicable to simulating, modeling, and/or measuring any of a variety of aspects of an environment. Non-limiting examples of ray tracing include ray casting, recursive ray tracing, distribution ray tracing, photon mapping, and path tracing.

Ray tracing may be used to simulate a variety of optical effects—such as shadows, reflections, refractions, scattering phenomenon, ambient occlusions, global illuminations, or dispersion phenomenon (such as chromatic aberration). Ray tracing may involve generating ray-traced samples by casting rays in a virtual environment to sample lighting and/or other environmental conditions for pixels. The ray traced samples may be combined and used to determine pixel colors for an image. In at least one embodiment, to conserve computing resources, the lighting conditions may be sparsely sampled, resulting in noisy render data. Temporal accumulation may be used to increase the effective sample count by using information from previous frames. To produce a final render that approximates a render of a fully sampled scene, one or more denoising filters may by be applied to the noisy render data to reduce noise.

Many ray tracing algorithms may cast or shoot rays from a virtual camera, or eye, through a 2D viewing plane (e.g., a pixel plane) out into a 3D scene which may include one or more light sources. Some rays may directly reach the viewing plane from a light source, some may be blocked by an object in the scene causing shadows, and some may reflect or refract off an object before reaching the viewing plane. When the rays intersect objects, the color and lighting information at the points of intersection on object surfaces may contribute to various pixel color and illumination levels of pixels of the viewing plane. Different objects may have different surface properties that can cause them to reflect, refract, or absorb light in different ways, which may be accounted for in ray tracing. Rays may reflect off objects and hit other objects, or travel through the surfaces of transparent objects before reaching a light source, and the color and lighting information from all the intersected objects may contribute to the final pixel colors.

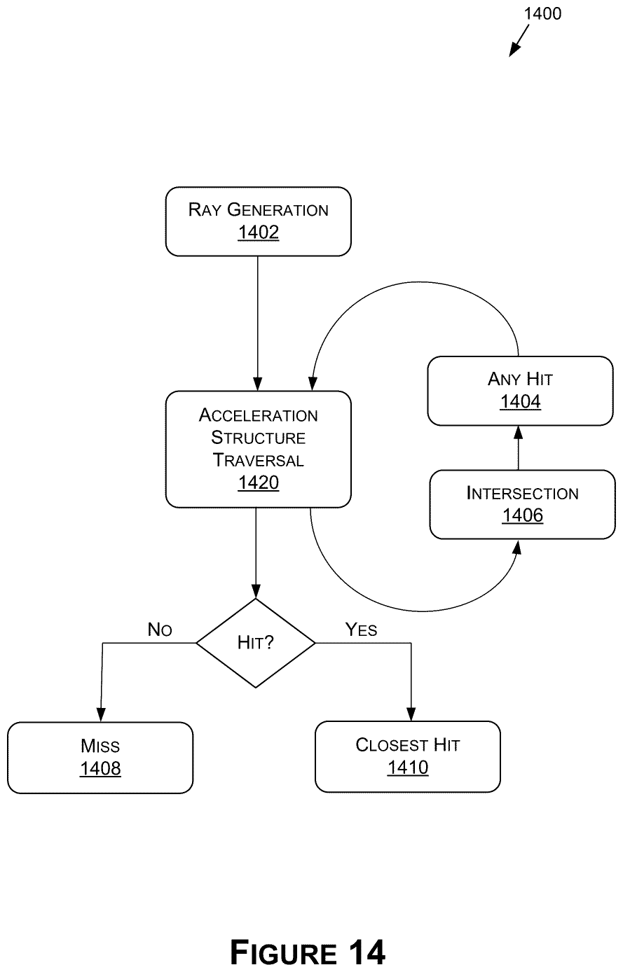

FIG. 14 illustrates an example ray tracing pipeline 1400 suitable for use in implementing at least some embodiments of the present disclosure. By way of example, and not limitations, the ray tracing pipeline 1400 may be implemented by the PPU 1100 of FIG. 11, in accordance with at least one embodiment. The ray tracing pipeline 1400 may include processing steps implemented to generate 2D computer-generated images from 3D geometry data using one or more ray tracing techniques.

In at least one embodiment, the ray tracing pipeline 1400 may be constructed using one or more ray generation shaders 1402, one or more any hit shaders 1404, one or more intersection shaders 1406, one or more miss shaders 1408, and/or one or more closest hit shaders 1410.

The ray tracing pipeline 1400 may be implemented via an application executed by a host processor, such as a CPU. In at least one embodiment, a device driver may implement an application programming interface (API) that defines various functions that can be used by an application in order to generate graphical data for display. The device driver may refer to a software program that includes instructions that control the operation of the PPU 1100, or other PPU used to implement the ray tracing pipeline 1400. The API may provide an abstraction for a programmer that lets a programmer use specialized graphics hardware, such as the PPU 1100, to generate the graphical data without requiring the programmer to use the specific instruction set for the PPU 1100. The application may include an API call that is routed to the device driver for the PPU 1100. The device driver may interpret the API call and perform various operations to respond to the API call. In at least one embodiment, the device driver performs operations by executing instructions on the CPU. In at least one embodiment, the device driver performs operations, at least in part, by launching operations on the PPU 1100 using an input/output interface between the CPU and the PPU 1100. In at least one embodiment, the device driver is configured to implement the ray tracing pipeline 1400 using the hardware of the PPU 1100.

Various programs may be executed within the PPU 1100 in order to implement the various stages of the ray tracing pipeline 1400. For example, the device driver may launch a kernel on the PPU 1100 to execute a stage implementing a ray generation shader 1402 on an SM 1240 (or multiple SMs 1240). The device driver (or the initial kernel executed by the PPU 1100) may also launch other kernels on the PPU 1100 to execute other stages of the ray tracing pipeline 1400.

The ray generation shader 1402 may be the first shader involved in ray tracing dispatch. The ray generation shader 1402 may call a High Level Shader Language (HLSL) function called TraceRay( ). This TraceRay( ) function may cast a single ray into the scene to search for intersections, which may trigger other shaders in the process. In at least one embodiment, the ray generation shader 1402 may call TraceRay( ) any number of times.

An any hit shader 1404 and an intersection shader 1406 may be invoked whenever TraceRay( ) finds a potential intersection between the ray and the scene. The intersection shader 1406 may determine whether the ray intersects an individual geometric primitive—for example a sphere, a subdivision surface, a triangle, or other form of primitive. Once an intersection is found, the any hit shader 1404 may be used to process the intersection further or potentially discard the intersection. An any hit shader 1404 may, by way of example and not limitation, use alpha testing by performing a texture lookup and deciding based on the texel's value whether or not to discard an intersection.

Once TraceRay( ) has completed the search for ray-scene intersections, either a miss shader 1408 or a closest hit shader 1410 may be invoked, depending on the outcome of the search. The closest hit shader 1410 may perform most shading operations, such as, material evaluation, texture lookups, and so on. The miss shader 1408 may be used to implement environment lookups, for example. In at least one embodiment, one or more of the closest hit shader 1410 or the miss shader 1408 may recursively trace rays by calling TraceRay( ) themselves.

The ray tracing pipeline 1400 constructed from any of the various shaders described herein may define a single-ray programming model. In at least one embodiment, each thread of the PPU 1100, and/or other PPU used to implement the ray tracing pipeline 1400, may handle one ray at a time. In at least one embodiment, each thread cannot communicate with other threads or see other rays currently being processed. This may simplify shader code, while allowing for vendor-specific optimizations using the API.

In at least one embodiment, different shaders and/or shader types may communicate with each other using a ray payload. A ray payload may refer to a user-defined struct that's passed as an INOUT parameter to TraceRay( ). For example, an any hit shader 1404, a closest hit shader 1410, and/or a miss shader 1408 may read from and/or write to the ray payload, and therefore pass back the result of their computations to the caller of TraceRay( ).

In at least one embodiment, a ray generation shader 1402 may trace primary rays, which may include rays being sent into the scene originating from a virtual camera. However, ray generation shaders 1402 are not limited to this functionality. In at least one embodiment, a ray generation shader 1402 may base ray generation on rasterized g-buffer data (e.g., to trace reflections). Using this approach, ray tracing may be used to complement rasterization, rather than replace rasterization.

When using traditional rasterization, only the shaders required by the current object being drawn may have to be active on the PPU. This may allow rasterization pipeline objects to be relatively small, containing a single set of vertex shaders, pixel shaders, etc. In contrast, a ray tracing pipeline 1400 may be used to arbitrarily shoot rays into the scene. This may mean the rays could hit any object or many objects in the scene. Therefore, it may be the case that all shaders for all objects could potentially be hit and therefore it may be desirable for the shaders to all be resident on the PPU and ready for execution.

In at least one embodiment, a state object may be used to group shaders together for execution. At a high level, a state object of a ray tracing pipeline 1400 may be seen as a binary executable resulting from a link step across all the shaders compiled for the scene. The relationship between different shaders may be specified at state object creation. For example, triplets of intersection shaders 1406, any hit shaders 1404, and/or closest hit shaders 1410 may be bundled into hit groups. The application may specify the state object of the ray tracing pipeline 1400 to be executed when calling a DispatchRays( ) function on a command list. A DispathRays( ) function may invoke a ray generation shader 1402 for each pixel for an image. In at least one embodiment, an application may create any number of state objects for a ray tracing pipeline 1400 and may re-use precompiled shaders for this purpose.

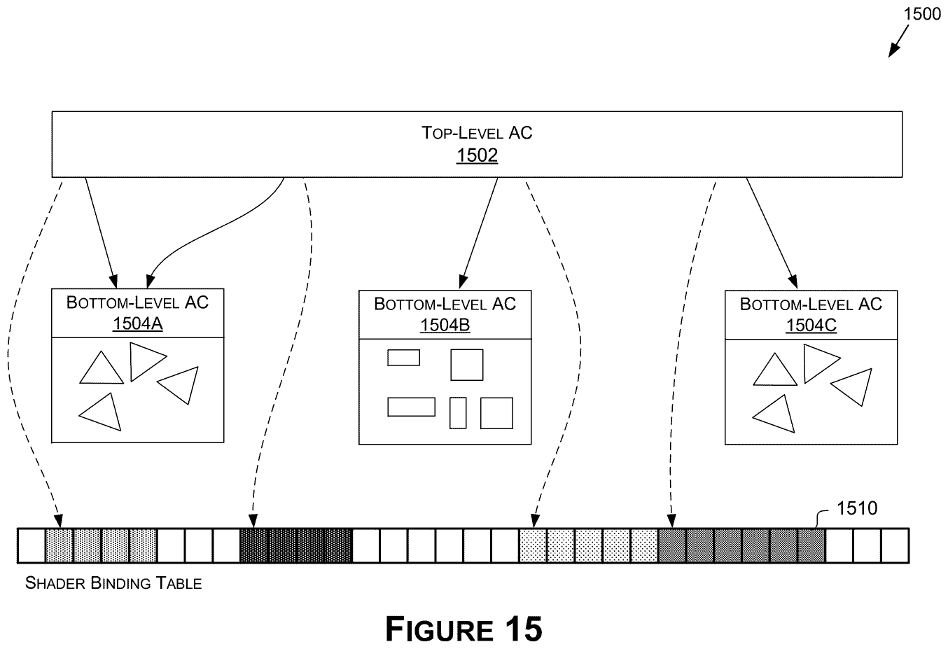

Referring now to FIG. 15, FIG. 15 illustrates an example acceleration structure 1500 suitable for use in implementing at least some embodiments of the present disclosure. The acceleration structure 1500 includes one or more top-level acceleration structures, such as a top-level acceleration structure 1502, and one or more bottom-level acceleration structures, such as bottom-level acceleration structures 1504A, 1504B, and 1504C.

The acceleration structure 1500 may comprise a spatial search data structure used in a ray tracing pipeline 1400 for acceleration structure traversal 1420 to efficiently compute intersections of rays with scene geometry. In at least one embodiment, the application may build an acceleration structure 1500 explicitly using a command list method BuildRaytracingAccelerationStructure( ). In at least one embodiment, the application may optimize an acceleration structure 1500 for different types of content, such as static versus animated content.

A top-level acceleration structure 1502 may be built from one or more references to one or more bottom-level acceleration structures 1504A, 1504B, and/or 1504C. These references may be referred to as instance descriptors. Each instance descriptor may include a transformation matrix to position the instance descriptor in the scene, and an offset into a shader table 1510 (which may also be referred to as a “shader binding table”) to locate material information. In at least one embodiment, a top-level acceleration structure 1502 may be used as a scene parameter provided to TraceRay( ) in a ray generation shader 1402, and may represent an entry point of the intersection search.

A ray tracing pipeline 1400 may specify the shaders that exist in a scene and an acceleration structure 1500 may specify geometry for the scene. The shader table 1510 may refer to a data structure used to tie the geometry to the shaders. For example, the shader table 1510 may define which shader is associated with which object in the scene. In addition, the shader table 1510 may hold information about the resources accessed by each shader, such as textures, buffers, and constants.

A shader table 1510 may comprise a chunk of PPU memory, which may be managed by the application. The application may be responsible for allocating the resource, filling the shader table 1510 with valid data, transferring it to the PPU, and correctly synchronizing the shader table 1510 with ray tracing dispatches. The application may also maintain multiple shader tables 1510, and, for example, multi-buffer them to update one copy while using another for rendering.

A shader table 1510 may comprise an array of equal-sized shader records. Each shader record may associate a shader (or a hit group) with a set of resources. In at least one embodiment, there may exist one record per geometry object in the scene, and a shader table 1510 may include thousands of entries or more.

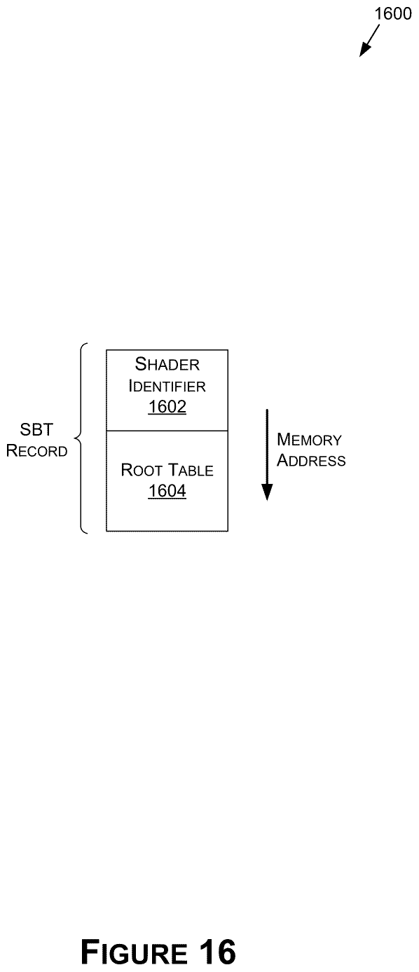

Referring now to FIG. 16, FIG. 16 illustrates an example shader record 1600 suitable for use in implementing at least some embodiments of the present disclosure. The shader record 1600 is an example of a shader record that may be included in the shader table 1510 of FIG. 15. The shader record 1600 includes a shader identifier 1602 and a root table 1604.

In at least one embodiment, the shader identifier 1602 may be represented in a beginning portion of the shader record 1600 in memory. The shader identifier 1602 may be an opaque identifier, which the application obtains by querying for the shader identifier 1602 from a compiled shader. The root table 1604 may contain the shader's resources. The layout of the root table 1604 may be defined by the shader's local root signature. The root signature may contain any combination of constants, descriptor tables, and root descriptors. For ray tracing, the application may directly access the root table 1604 in memory (e.g., rather than using “setter” methods), which may allow for efficient updates. In at least one embodiment, a shader table 1510 may be updated from a PPU shader.

As described herein, shader table offsets may be used when building a top-level acceleration structure 1502 from instance descriptors. The system may use these offsets to locate the correct shader record 1600 whenever TraceRay( ) finds an intersection. The system may then bind the resources defined in the shader record 1600 and execute the appropriate shader for the intersected geometry.

### Example Computing Device

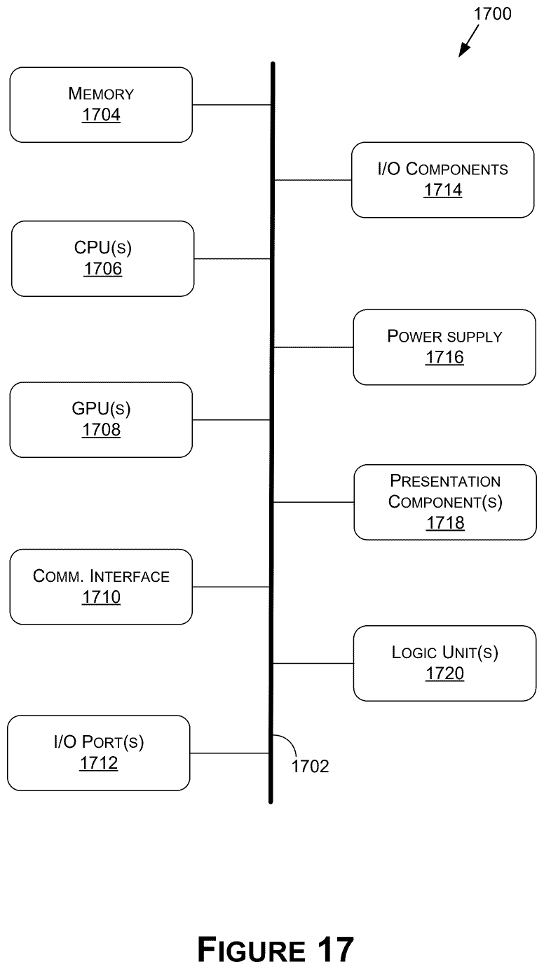

FIG. 17 is a block diagram of an example computing device(s) 1700 suitable for use in implementing at least some embodiments of the present disclosure. Computing device 1700 may include an interconnect system 1702 that directly or indirectly couples the following devices: memory 1704, one or more central processing units (CPUs) 1706, one or more graphics processing units (GPUs) 1708, a communication interface 1710, input/output (I/O) ports 1712, input/output components 1714, a power supply 1716, one or more presentation components 1718 (e.g., display(s)), and one or more logic units 1720. In at least one embodiment, the computing device(s) 1700 may comprise one or more virtual machines (VMs), and/or any of the components thereof may comprise virtual components (e.g., virtual hardware components). For non-limiting examples, one or more of the GPUs 1708 may comprise one or more pups, one or more of the CPUs 1706 may comprise one or more vCPUs, and/or one or more of the logic units 1720 may comprise one or more virtual logic units. As such, a computing device(s) 1700 may include discrete components (e.g., a full GPU dedicated to the computing device 1700), virtual components (e.g., a portion of a GPU dedicated to the computing device 1700), or a combination thereof.

Although the various blocks of FIG. 17 are shown as connected via the interconnect system 1702 with lines, this is not intended to be limiting and is for clarity only. For example, in some embodiments, a presentation component 1718, such as a display device, may be considered an I/O component 1714 (e.g., if the display is a touch screen). As another example, the CPUs 1706 and/or GPUs 1708 may include memory (e.g., the memory 1704 may be representative of a storage device in addition to the memory of the GPUs 1708, the CPUs 1706, and/or other components). In other words, the computing device of FIG. 17 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 17.

The interconnect system 1702 may represent one or more links or busses, such as an address bus, a data bus, a control bus, or a combination thereof. The interconnect system 1702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1706 may be directly connected to the memory 1704. Further, the CPU 1706 may be directly connected to the GPU 1708. Where there is direct, or point-to-point connection between components, the interconnect system 1702 may include a PCIe link to carry out the connection. In these examples, a PCI bus need not be included in the computing device 1700.

The memory 1704 may include any of a variety of computer-readable media. The computer-readable media may be any available media that may be accessed by the computing device 1700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1706 may be configured to execute at least some of the computer-readable instructions to control one or more components of the computing device 1700 to perform one or more of the methods and/or processes described herein. The CPU(s) 1706 may each include one or more cores (e.g., one, two, four, eight, twenty-eight, seventy-two, etc.) that are capable of handling a multitude of software threads simultaneously. The CPU(s) 1706 may include any type of processor, and may include different types of processors depending on the type of computing device 1700 implemented (e.g., processors with fewer cores for mobile devices and processors with more cores for servers). For example, depending on the type of computing device 1700, the processor may be an Advanced RISC Machines (ARM) processor implemented using Reduced Instruction Set Computing (RISC) or an x86 processor implemented using Complex Instruction Set Computing (CISC). The computing device 1700 may include one or more CPUs 1706 in addition to one or more microprocessors or supplementary co-processors, such as math co-processors.

In addition to or alternatively from the CPU(s) 1706, the GPU(s) 1708 may be configured to execute at least some of the computer-readable instructions to control one or more components of the computing device 1700 to perform one or more of the methods and/or processes described herein. One or more of the GPU(s) 1708 may be an integrated GPU (e.g., with one or more of the CPU(s) 1706 and/or one or more of the GPU(s) 1708 may be a discrete GPU. In embodiments, one or more of the GPU(s) 1708 may be a coprocessor of one or more of the CPU(s) 1706. The GPU(s) 1708 may be used by the computing device 1700 to render graphics (e.g., 3D graphics) or perform general purpose computations. For example, the GPU(s) 1708 may be used for General-Purpose computing on GPUs (GPGPU). The GPU(s) 1708 may include hundreds or thousands of cores that are capable of handling hundreds or thousands of software threads simultaneously. The GPU(s) 1708 may generate pixel data for output images in response to rendering commands (e.g., rendering commands from the CPU(s) 1706 received via a host interface). The GPU(s) 1708 may include graphics memory, such as display memory, for storing pixel data or any other suitable data, such as GPGPU data. The display memory may be included as part of the memory 1704. The GPU(s) 1708 may include two or more GPUs operating in parallel (e.g., via a link). The link may directly connect the GPUs (e.g., using NVLINK) or may connect the GPUs through a switch (e.g., using NVSwitch). When combined together, each GPU 1708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1706 and/or the GPU(s) 1708, the logic unit(s) 1720 may be configured to execute at least some of the computer-readable instructions to control one or more components of the computing device 1700 to perform one or more of the methods and/or processes described herein. In embodiments, the CPU(s) 1706, the GPU(s) 1708, and/or the logic unit(s) 1720 may discretely or jointly perform any combination of the methods, processes and/or portions thereof. One or more of the logic units 1720 may be part of and/or integrated in one or more of the CPU(s) 1706 and/or the GPU(s) 1708 and/or one or more of the logic units 1720 may be discrete components or otherwise external to the CPU(s) 1706 and/or the GPU(s) 1708. In embodiments, one or more of the logic units 1720 may be a coprocessor of one or more of the CPU(s) 1706 and/or one or more of the GPU(s) 1708.

Examples of the logic unit(s) 1720 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1710 may include one or more receivers, transmitters, and/or transceivers that enable the computing device 1700 to communicate with other computing devices via an electronic communication network, included wired and/or wireless communications. The communication interface 1710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1720 and/or communication interface 1710 may include one or more data processing units (DPUs) to transmit data received over a network and/or through interconnect system 1702 directly to (e.g., a memory of) one or more GPU(s) 1708.

The I/O ports 1712 may enable the computing device 1700 to be logically coupled to other devices including the I/O components 1714, the presentation component(s) 1718, and/or other components, some of which may be built in to (e.g., integrated in) the computing device 1700. Illustrative I/O components 1714 include a microphone, mouse, keyboard, joystick, game pad, game controller, satellite dish, scanner, printer, wireless device, etc. The I/O components 1714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1700. The computing device 1700 may be include depth cameras, such as stereoscopic camera systems, infrared camera systems, RGB camera systems, touchscreen technology, and combinations of these, for gesture detection and recognition. Additionally, the computing device 1700 may include accelerometers or gyroscopes (e.g., as part of an inertia measurement unit (IMU)) that enable detection of motion. In some examples, the output of the accelerometers or gyroscopes may be used by the computing device 1700 to render immersive augmented reality or virtual reality.

The power supply 1716 may include a hard-wired power supply, a battery power supply, or a combination thereof. The power supply 1716 may provide power to the computing device 1700 to enable the components of the computing device 1700 to operate.

The presentation component(s) 1718 may include a display (e.g., a monitor, a touch screen, a television screen, a heads-up-display (HUD), other display types, or a combination thereof), speakers, and/or other presentation components. The presentation component(s) 1718 may receive data from other components (e.g., the GPU(s) 1708, the CPU(s) 1706, DPUs, etc.), and output the data (e.g., as an image, video, sound, etc.).

### Example Data Center

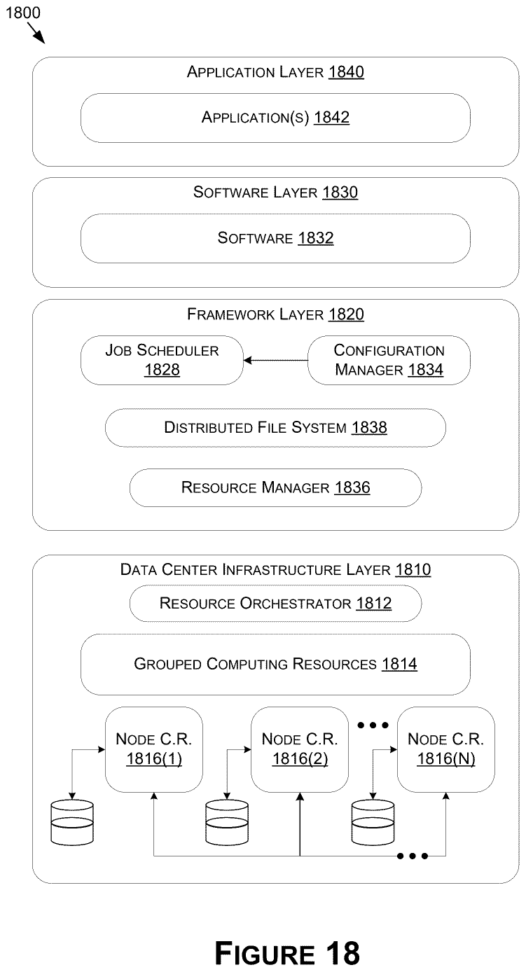

FIG. 18 illustrates an example data center 1800 that may be used in at least one embodiments of the present disclosure. The data center 1800 may include a data center infrastructure layer 1810, a framework layer 1820, a software layer 1830, and/or an application layer 1840.

As shown in FIG. 18, the data center infrastructure layer 1810 may include a resource orchestrator 1812, grouped computing resources 1814, and node computing resources (“node C.R.s”) 1816(1)-1816(N), where “N” represents any whole, positive integer. In at least one embodiment, node C.R.s 1816(1)-1816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1816(1)-1816(N) may correspond to a server having one or more of the above-mentioned computing resources. In addition, in some embodiments, the node C.R.s 1816(1)-18161(N) may include one or more virtual components, such as vGPUs, vCPUs, and/or the like, and/or one or more of the node C.R.s 1816(1)-1816(N) may correspond to a virtual machine (VM).

In at least one embodiment, grouped computing resources 1814 may include separate groupings of node C.R.s 1816 housed within one or more racks (not shown), or many racks housed in data centers at various geographical locations (also not shown). Separate groupings of node C.R.s 1816 within grouped computing resources 1814 may include grouped compute, network, memory or storage resources that may be configured or allocated to support one or more workloads. In at least one embodiment, several node C.R.s 1816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1812 may configure or otherwise control one or more node C.R.s 1816(1)-1816(N) and/or grouped computing resources 1814. In at least one embodiment, resource orchestrator 1812 may include a software design infrastructure (SDI) management entity for the data center 1800. The resource orchestrator 1812 may include hardware, software, or some combination thereof.

In at least one embodiment, as shown in FIG. 18, framework layer 1820 may include a job scheduler 1828, a configuration manager 1834, a resource manager 1836, and/or a distributed file system 1838. The framework layer 1820 may include a framework to support software 1832 of software layer 1830 and/or one or more application(s) 1842 of application layer 1840. The software 1832 or application(s) 1842 may respectively include web-based service software or applications, such as those provided by Amazon Web Services, Google Cloud and Microsoft Azure. The framework layer 1820 may be, but is not limited to, a type of free and open-source software web application framework such as Apache Spark™ (hereinafter “Spark”) that may utilize distributed file system 1838 for large-scale data processing (e.g., “big data”). In at least one embodiment, job scheduler 1828 may include a Spark driver to facilitate scheduling of workloads supported by various layers of data center 1800. The configuration manager 1834 may be capable of configuring different layers such as software layer 1830 and framework layer 1820 including Spark and distributed file system 1838 for supporting large-scale data processing. The resource manager 1836 may be capable of managing clustered or grouped computing resources mapped to or allocated for support of distributed file system 1838 and job scheduler 1828. In at least one embodiment, clustered or grouped computing resources may include grouped computing resource 1814 at data center infrastructure layer 1810. The resource manager 1836 may coordinate with resource orchestrator 1812 to manage these mapped or allocated computing resources.

In at least one embodiment, software 1832 included in software layer 1830 may include software used by at least portions of node C.R.s 1816(1)-1816(N), grouped computing resources 1814, and/or distributed file system 1838 of framework layer 1820. One or more types of software may include, but are not limited to, Internet web page search software, e-mail virus scan software, database software, and streaming video content software.

In at least one embodiment, application(s) 1842 included in application layer 1840 may include one or more types of applications used by at least portions of node C.R.s 1816(1)-1816(N), grouped computing resources 1814, and/or distributed file system 1838 of framework layer 1820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1834, resource manager 1836, and resource orchestrator 1812 may implement any number and type of self-modifying actions based on any amount and type of data acquired in any technically feasible fashion. Self-modifying actions may relieve a data center operator of data center 1800 from making possibly bad configuration decisions and possibly avoiding underused and/or poor performing portions of a data center.

The data center 1800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1800. In at least one embodiment, trained or deployed machine learning models corresponding to one or more neural networks may be used to infer or predict information using resources described above with respect to the data center 1800 by using weight parameters calculated through one or more training techniques, such as but not limited to those described herein.

In at least one embodiment, the data center 1800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1700 of FIG. 17—e.g., each device may include similar components, features, and/or functionality of the computing device(s) 1700. In addition, where backend devices (e.g., servers, NAS, etc.) are implemented, the backend devices may be included as part of a data center 1800, an example of which is described in more detail herein with respect to FIG. 18.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1700 described herein with respect to FIG. 17. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: determining, based at least on a plurality of samples indicative of a plurality of light sources illuminating at least a portion of a virtual environment depicted in an image, one or more first weights corresponding to one or more first light sources of the plurality of light sources, and one or more second weights corresponding to one or more second light sources of the plurality of light sources; storing, in one or more reservoirs corresponding to one or more pixels of the image and based at least on the one or more first weights being greater than the one or more second weights, one or more statistics associated with the one or more first light sources; and rendering, using the one or more statistics, one or more second images depicting one or more second portions of the virtual environment.

B. The method of paragraph A, further comprising: generating, based at least on the one or more statistics, one or more light sampling distributions corresponding to one or more portions of the image; and sampling, based at least on the one or more light sampling distributions, the plurality of light sources illuminating one or more second portions of the virtual environment, wherein the rendering of the one or more second images is based at least on the sampling.

C. The method of any one of paragraphs A-B, further comprising: determining one or more first relative contributions of the one or more first light sources to one or more radiance values of the one or more pixels in the image, wherein the one or more first weights are based at least on the one or more first relative contributions; and determining one or more second relative contributions of the one or more second light sources to the one or more radiance values of the one or more pixels in the image, wherein the one or more second weights are based at least on the one or more second relative contributions.

D. The method of any one of paragraphs A-C, wherein the one or more statistics associated with the one or more first light sources include at least: one or more identifiers corresponding to the one or more first light sources; the one or more first weights corresponding to the one or more first light sources; and one or more total weights including one or more sums of the one or more first weights and the one or more second weights.

E. The method of any one of paragraphs A-D, wherein the storing, in the one or more reservoirs, of the one or more statistics associated with the one or more first light sources comprises: storing, in the one or more reservoirs and at a first time during a rendering pass, one or more second statistics associated with the one or more second light sources; and storing, in the one or more reservoirs and at a second time after the first time during the rendering pass, the one or more statistics associated with the one or more first light sources instead of the one or more second statistics associated with the one or more second light sources based at least on the one or more first weights being greater than the one or more second weights.

F. The method of any one of paragraphs A-E, further comprising: determining one or more first contributions of the one or more first light sources to one or more specular radiance values of the one or more pixels in the image; and determining one or more second contributions of the one or more first light sources to one or more diffuse radiance values of the one or more pixels in the image, wherein the one or more first weights are based at least on the one or more first contributions and the one or more second contributions.

G. The method of any one of paragraphs A-F, further comprising: determining, based at least on the plurality of samples, one or more materials of one or more surfaces in the virtual environment that are illuminated by the one or more first light sources and the one or more second light sources, wherein the determining of the one or more first weights and the one or more second weights are further based at least on the one or more materials of the one or more surfaces.

H. A system comprising: one or more processors to: obtain light sampling statistics indicative of a plurality of light sources that contribute, by more than a threshold, to illumination of one or more surfaces in a virtual environment depicted in a first image; generate, based at least on the light sampling statistics, a first sampling distribution corresponding to a first portion of the first image, the first sampling distribution indicative of a first ranking of the plurality of light sources based at least on contributions of the plurality of light sources to pixel radiance values for the first portion of the first image; generate, based at least on the light sampling statistics, one or more second sampling distributions corresponding to one or more second portions of the first image, the one or more second sampling distributions indicative of one or more second rankings of one or more subsets of the plurality of light sources based at least on contributions of the one or more subsets of the plurality of light sources to the pixel radiance values for the one or more second portions of the first image; and render, based at least on the first sampling distribution and the one or more second sampling distributions, a second image depicting the virtual environment.

I. The system of paragraph H, the one or more processors further to: sample, based at least on the first sampling distribution and the one or more second sampling distributions, the plurality of light sources of the virtual environment, wherein the rendering of the second image is based at least on the sampling.

J. The system of any one of paragraphs H-I, wherein: the first portion of the first image includes the one or more second portions of the first image, and the one or more second portions of the first image correspond to one or more pixel tiles including one or more groups of pixels of the first image.

K. The system of any one of paragraphs H-J, the one or more processors further to: determine, based at least on the light sampling statistics, a number of times that each light source of the plurality of light sources was included in the light sampling statistics; and compute, based at least on the number of times and a total number of pixels in the first image, one or more weights corresponding to each light source of the plurality of light sources, wherein the generation of the first sampling distribution is based at least on the computation of the one or more weights.

L. The system of any one of paragraphs H-K, the one or more processors further to: determine, based at least on the light sampling statistics, that a first light source of the plurality of light sources is a highest contributing light source to the pixel radiance values for a first number of pixels in the first image; determine, based at least on the light sampling statistics, that a second light source of the plurality of light sources is the highest contributing light source to the pixel radiance values for a second number of pixels in the first image; and associate, with the first light source, a first weight that is greater than a second weight associated with the second light source based at least on the first number of pixels being greater than the second number of pixels.

M. The system of any one of paragraphs H-L, the one or more processors further to: compute, for each light source of the plurality of light sources, a weight based at least on an emissive flux associated with each light source, wherein the generation of the first sampling distribution is further based at least on the weight associated with each light source.

N. The system of any one of paragraphs H-M, the one or more processors further to obtain the light sampling statistics from a plurality of reservoirs corresponding to pixels of the first image, wherein first light sampling statistics stored in a first reservoir corresponding to a first pixel of the first image include at least: an identifier of a first light source of the plurality of light sources that contributed most to a radiance of the first pixel in the first image; a first weight associated with the first light source; and a combination of the first weight and one or more second weights of one or more second light sources that contributed to the radiance of the first pixel.

O. The system of any one of paragraphs H-N, wherein: the first sampling distribution corresponding to the first portion of the first image is a global light importance sampling distribution corresponding to an entire portion of the first image, and the one or more second sampling distributions corresponding to the one or more second portions of the first image include one or more local light importance sampling distributions corresponding to one or more groups of pixels within the first image.

P. The system of any one of paragraphs H-O, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.

Q. One or more processors comprising: processing circuitry to render one or more images depicting a virtual environment based at least on using a plurality of sampling distributions to sample a plurality of light sources illuminating the virtual environment, wherein the plurality of sampling distributions include, at least: a first sampling distribution indicative of a first ranking of the plurality of light sources with respect to contributions of the plurality of light sources to pixel radiance values throughout an entire portion of one or more previously rendered images; and one or more second sampling distributions indicative of one or more second rankings of one or more subsets of the plurality of light sources with respect to contributions to pixel radiance values in one or more portions of the one or more previously rendered images.

R. The one or more processors of paragraph Q, wherein the sampling of the plurality of light sources illuminating the virtual environment comprises computing one or more probability density functions corresponding to one or more light samples from at least one of the first sampling distribution or the one or more second sampling distributions.

S. The one or more processors of any one of paragraphs Q-R, the one or more processors further to generate the plurality of sampling distributions based at least on light sampling statistics stored in one or more reservoirs corresponding to one or more pixels of the one or more previously rendered images, the light sampling statistics indicative of a contribution of particular light sources to illumination of one or more surfaces depicted in the one or more previously rendered images.

T. The one or more processors of any one of paragraphs Q-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package (e.g., a container); a system implemented at least partially in a data center; or a system implemented at least partially using cloud computing resources.

What is claimed is:

1. A method comprising:
determining, based at least on a plurality of samples indicative of a plurality of light sources illuminating at least a portion of a virtual environment depicted in an image, one or more first weights corresponding to one or more first light sources of the plurality of light sources, and one or more second weights corresponding to one or more second light sources of the plurality of light sources;
storing, in one or more reservoirs corresponding to one or more pixels of the image and based at least on the one or more first weights being greater than the one or more second weights, one or more statistics associated with the one or more first light sources; and
rendering, using the one or more statistics, one or more second images depicting one or more second portions of the virtual environment.

2. The method of claim 1, further comprising:
generating, based at least on the one or more statistics, one or more light sampling distributions corresponding to one or more portions of the image; and
sampling, based at least on the one or more light sampling distributions, the plurality of light sources illuminating one or more second portions of the virtual environment,
wherein the rendering of the one or more second images is based at least on the sampling.

3. The method of claim 1, further comprising:
determining one or more first relative contributions of the one or more first light sources to one or more radiance values of the one or more pixels in the image, wherein the one or more first weights are based at least on the one or more first relative contributions; and
determining one or more second relative contributions of the one or more second light sources to the one or more radiance values of the one or more pixels in the image, wherein the one or more second weights are based at least on the one or more second relative contributions.

4. The method of claim 1, wherein the one or more statistics associated with the one or more first light sources include at least:
one or more identifiers corresponding to the one or more first light sources;
the one or more first weights corresponding to the one or more first light sources; and
one or more total weights including one or more sums of the one or more first weights and the one or more second weights.

5. The method of claim 1, wherein the storing, in the one or more reservoirs, of the one or more statistics associated with the one or more first light sources comprises:
storing, in the one or more reservoirs and at a first time during a rendering pass, one or more second statistics associated with the one or more second light sources; and
storing, in the one or more reservoirs and at a second time after the first time during the rendering pass, the one or more statistics associated with the one or more first light sources instead of the one or more second statistics associated with the one or more second light sources based at least on the one or more first weights being greater than the one or more second weights.

6. The method of claim 1, further comprising:
determining one or more first contributions of the one or more first light sources to one or more specular radiance values of the one or more pixels in the image; and
determining one or more second contributions of the one or more first light sources to one or more diffuse radiance values of the one or more pixels in the image,
wherein the one or more first weights are based at least on the one or more first contributions and the one or more second contributions.

7. The method of claim 1, further comprising:
determining, based at least on the plurality of samples, one or more materials of one or more surfaces in the virtual environment that are illuminated by the one or more first light sources and the one or more second light sources,
wherein the determining of the one or more first weights and the one or more second weights are further based at least on the one or more materials of the one or more surfaces.

8. A system comprising:
one or more processors to:
obtain light sampling statistics indicative of a plurality of light sources that contribute, by more than a threshold, to illumination of one or more surfaces in a virtual environment depicted in a first image;
generate, based at least on the light sampling statistics, a first sampling distribution corresponding to a first portion of the first image, the first sampling distribution indicative of a first ranking of the plurality of light sources based at least on contributions of the plurality of light sources to pixel radiance values for the first portion of the first image;
generate, based at least on the light sampling statistics, one or more second sampling distributions corresponding to one or more second portions of the first image, the one or more second sampling distributions indicative of one or more second rankings of one or more subsets of the plurality of light sources based at least on contributions of the one or more subsets of the plurality of light sources to the pixel radiance values for the one or more second portions of the first image; and
render, based at least on the first sampling distribution and the one or more second sampling distributions, a second image depicting the virtual environment.

9. The system of claim 8, the one or more processors further to:
sample, based at least on the first sampling distribution and the one or more second sampling distributions, the plurality of light sources of the virtual environment,
wherein the rendering of the second image is based at least on the sampling.

10. The system of claim 8, wherein:
the first portion of the first image includes the one or more second portions of the first image, and
the one or more second portions of the first image correspond to one or more pixel tiles including one or more groups of pixels of the first image.

11. The system of claim 8, the one or more processors further to:
determine, based at least on the light sampling statistics, a number of times that each light source of the plurality of light sources was included in the light sampling statistics; and
compute, based at least on the number of times and a total number of pixels in the first image, one or more weights corresponding to each light source of the plurality of light sources,
wherein the generation of the first sampling distribution is based at least on the computation of the one or more weights.

12. The system of claim 8, the one or more processors further to:
determine, based at least on the light sampling statistics, that a first light source of the plurality of light sources is a highest contributing light source to the pixel radiance values for a first number of pixels in the first image;
determine, based at least on the light sampling statistics, that a second light source of the plurality of light sources is the highest contributing light source to the pixel radiance values for a second number of pixels in the first image; and
associate, with the first light source, a first weight that is greater than a second weight associated with the second light source based at least on the first number of pixels being greater than the second number of pixels.

13. The system of claim 8, the one or more processors further to:
compute, for each light source of the plurality of light sources, a weight based at least on an emissive flux associated with each light source, and
wherein the generation of the first sampling distribution is further based at least on the weight associated with each light source.

14. The system of claim 8, the one or more processors further to obtain the light sampling statistics from a plurality of reservoirs corresponding to pixels of the first image, wherein first light sampling statistics stored in a first reservoir corresponding to a first pixel of the first image include at least:
an identifier of a first light source of the plurality of light sources that contributed most to a radiance of the first pixel in the first image;
a first weight associated with the first light source; and
a combination of the first weight and one or more second weights of one or more second light sources that contributed to the radiance of the first pixel.

15. The system of claim 8, wherein:
the first sampling distribution corresponding to the first portion of the first image is a global light importance sampling distribution corresponding to an entire portion of the first image, and
the one or more second sampling distributions corresponding to the one or more second portions of the first image include one or more local light importance sampling distributions corresponding to one or more groups of pixels within the first image.

16. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

17. One or more processors comprising:
processing circuitry to render one or more images depicting a virtual environment based at least on using a plurality of sampling distributions to sample a plurality of light sources illuminating the virtual environment, wherein the plurality of sampling distributions include, at least:
a first sampling distribution indicative of a first ranking of the plurality of light sources with respect to contributions of the plurality of light sources to pixel radiance values throughout an entire portion of one or more previously rendered images; and
one or more second sampling distributions indicative of one or more second rankings of one or more subsets of the plurality of light sources with respect to contributions to pixel radiance values in one or more portions of the one or more previously rendered images.

18. The one or more processors of claim 17, wherein the sampling of the plurality of light sources illuminating the virtual environment comprises computing one or more probability density functions corresponding to one or more light samples from at least one of the first sampling distribution or the one or more second sampling distributions.

19. The one or more processors of claim 17, the one or more processors further to generate the plurality of sampling distributions based at least on light sampling statistics stored in one or more reservoirs corresponding to one or more pixels of the one or more previously rendered images, the light sampling statistics indicative of a contribution of particular light sources to illumination of one or more surfaces depicted in the one or more previously rendered images.

20. The one or more processors of claim 17, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.
